(19) United States
(12) Patent Application Publication
(10) Pub. No.: US 2025/0117024 A1
(43) Pub. Date: Apr. 10, 2025

(54) AUTONOMOUS ASSEMBLY CONFIGURATOR AND METHODS FOR SAME

(71) Applicant: Raven Industries,Inc., Sioux Falls, SD (US)

(72) Inventors: Douglas L. Fick, Garretson, SD (US); Ryan Orlin Abel, Tea, SD (US); John D. Preheim, Beresford, SD (US); Jared Ernest Kocer, Sioux Falls, SD (US)

(21) Appl. No.: 18/912,219

(22) Filed: Oct. 10, 2024

Related U.S. Application Data
(60) Provisional application No. 63/589,222, filed on Oct. 10, 2023.

(51) Int. Cl. G05D 1/672; A01B 69/04; A01B 79/00; G05D 1/648; G05D 105/15; G05D 107/20

(52) U.S. Cl. CPC G05D 1/672; A01B 69/008; A01B 79/005; G05D 1/6484; G05D 2105/15; G05D 2107/21

(57) ABSTRACT

An autonomous agricultural assembly configurator includes one or more processors configured to receive one or more characteristic bundle inputs. Characteristic bundles include a field characteristic bundle associated with a field, an implement characteristic bundle associated with an agricultural implement, or a vehicle characteristic bundle associated with an agricultural vehicle. The configurator generates an autonomous configuration profile for an autonomous agricultural operation according to the received characteristic bundle inputs. Generation includes determining the autonomous agricultural operation based on the implement characteristic bundle, and determining operation parameters for the autonomous agricultural operation based on one or more of the implement characteristic bundle or the vehicle characteristic bundle. The one or more processors control the agricultural vehicle and the agricultural implement to conduct the agricultural operation according to the autonomous configuration profile.

### PRIORITY CLAIM

This application claims the benefit of priority to U.S. Provisional Application, Ser. No. 63/589,222, entitled AUTONOMOUS ASSEMBLY CONFIGURATOR AND CONTROLLER AND METHODS FOR SAME, filed on Oct. 10, 2023 (Attorney Docket No. 2754.515PRV), which is hereby incorporated by reference herein in its entirety, and is assigned to Raven Industries, Inc.

### INCORPORATION BY REFERENCE

This document incorporates by reference the entirety of U.S. Provisional Application, Ser. No. 63/024,979, entitled OBSTACLE MONITORING SYSTEMS AND METHODS FOR SAME; U.S. patent application Ser. No. 17/321,331, entitled OBSTACLE MONITORING SYSTEMS AND METHODS FOR SAME; and U.S. Provisional Application, Ser. No. 63/386,307, entitled AUTONOMOUS DRIVER SYSTEM FOR AGRICULTURAL VEHICLE ASSEMBLIES AND METHODS FOR SAME each assigned to Raven Industries, Inc.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota. All Rights Reserved.

### TECHNICAL FIELD

This document pertains generally, but not by way of limitation, to autonomous and semi-autonomous agricultural vehicles and agricultural implements.

### BACKGROUND

Agricultural vehicles and agricultural implements conduct a variety of agricultural operations according to their specified functions. Tilling is conducted with tilling implements, planting with planter or seeding implements, spraying with sprayers, cultivating with cultivating implements, harvesting is conducted with combines and so on. In some examples, the agricultural implements are coupled with standalone prime movers, such as tractors, to travel fields and conduct agricultural operations.

In some examples, a user couples an implement with the prime mover and one of the implement or prime mover includes autonomous or semi-autonomous driving along a planned route and (autonomous or semi-autonomous) agricultural operations with the implement along the planned route. For instance, the user or a technician inputs a field map and indexes a planned route and agricultural operation over the field map. The prime mover, such as a tractor, drives along the planned route and the implement conducts the agricultural operation (e.g., tilling, planting, spraying, cultivating, harvesting, grain cart transporting, mowing, baling or the like).

### OVERVIEW

The present inventors have recognized, among other things, that a problem to be solved includes overcoming agricultural autonomy systems that provide static or near statically implemented autonomous agricultural operations. Autonomous systems are developed with teams of developers with access to the agricultural vehicle (e.g., prime mover such as a tractor or combine) and agricultural implements (e.g., harvester heads, hitched implements or the like). Developers formulate autonomous operations based on the capabilities of the agricultural vehicle and agricultural implements including the onboard sensors, actuators, tools, dimensions or the like of the model of vehicle and implement under development. For instance, developers associated with an original equipment manufacturer (OEM) or autonomous controller designer conduct meetings between prime mover and implement teams to cooperatively develop a controller and an autonomous operation including initial discussion, coding, testing, and refinement based on the capabilities of the vehicle and implement. The developed autonomous operation is a control template for the operation and in some examples provides a gross approximation of human operator control of many facets of conducting an agricultural operation. For instance, in some examples, an autonomous controller and its associated control template provided with the OEM agricultural vehicle and implement receives a field model having specified boundaries or the like, and the controller generates a path plan for conduct of an agricultural operation with the agricultural vehicle and implement (referred to herein as an agricultural assembly). The path plan provides one or more guidance lines, way points or the like that permit automated guidance of the agricultural assembly through the field. The controller conducts the agricultural operation associated with the implement as it is guided according to the path plan.

In many examples, the autonomous controller for the autonomous operation fails to address situations that are readily addressed by human operators. In other examples, the controller may provide a solution or limited number of solutions that fail to satisfy a unique or preferred solution of a human operator or owner of the agricultural assembly. In one example, the autonomous operation provided with the controller provides a consistent end of row turn that is technically feasible for the assembly of the agricultural vehicle and implement, but is difficult in some instances for the assembly based on an obstacle, grade, variation in terrain or the like that is not accounted for in development of the autonomous operation. In this example, a human operator will override the autonomous operation to conduct refined and unique control that better addresses the end of row turn. For instance, the human operator raises sprayer booms to facilitate a turn, disengages or partially disengages a cultivator from the ground to facilitate the turn, varies the prime mover speed or turn pattern at particularly difficult portions of the turn, or the like.

In another example, an agricultural assembly conducts an autonomous spraying operation including prescribed spraying of an agricultural product, such as a fertilizer, herbicide, pesticide, fungicide or the like. The autonomous operation provided by the autonomous controller may account for broad application of the agricultural product while failing to account for acute and local issues, such as the need for additional application of the agricultural product because of an observed significant volume of a pest, a unique pest, weed or the like that may be addressed with a variation of the broad application (e.g., with a spot application of a different product or combination of products). In these examples, the human operator will intervene in the autonomous operation to provide a varied application to address the acute issue.

In these examples and others like them, the agricultural assembly of the agricultural vehicle and the agricultural implement includes one or more sensors, such as vision sensors, light detection and ranging (LiDAR) sensors or the like, that are used for conducting autonomous driving. However, these sensors are tasked at development for use with autonomous driving and not spraying, cultivating, planting or the like. In a similar manner, the agricultural implement and agricultural vehicle includes a multitude of actuators (e.g., motors, hydraulic pistons or the like) that are used for various specified functions, and could be used for some autonomous functions but are not used in those autonomous functions. For example, each of the vehicle and implement have existing respective control templates that make use of sensors and actuators in the manner specified during development of the respective controllers. The failure to use these sensors, actuators and other capabilities of the implements and vehicles for additional or improved autonomous functions are due in part to the inability to predict the needs of individual operators especially in light of variations in fields, crops, differences in agricultural vehicles and implements; failure to predict how sensors, actuators or the like can be used; the vast variations in operator driving and implement operations and preferences; failure to co-develop between implement and vehicle developers; lack of developer agricultural experience; rushed development; or the like. These issues are further frustrated with agricultural vehicles and implements that are used together but are developed by different OEMs or different autonomous controller designers.

The present subject matter can help provide a solution to this problem, with an autonomous assembly configurator and controller that facilitates the generation of autonomous agricultural operations, updating and refinement of those operations based on each of operator specifications as well as the full functions and capabilities of the component vehicles and implements; and optionally implementation (control) of the autonomous agricultural operation including updates and refinements. For instance, the configurator builds out an autonomous operation based on the received capabilities of a selected field, agricultural implement and agricultural vehicle instead of being an onboard autonomous operation control template that is previously developed based on a specified (e.g., host) agricultural vehicle, specified agricultural implement or the like and is constrained by the previous development.

The configurator includes one or more processors that receive characteristics for a field, implement and vehicle (including a vehicle having an integral implement). The characteristics are referred to as characteristic bundles and include one or more characteristics representative of features, functions or the like of the field, implement or vehicle. The characteristic bundles are received as separate file, and in other examples are received as a composite characteristic bundle including two or more component characteristic bundles (e.g., field and implement, implement and vehicle, vehicle and field, or the like).

Field characteristics include, but are not limited to, boundaries, keep out or exclusion zones, obstacle locations, planted crop characteristics (variety, height or the like), crop row spacing or the like. Implement characteristics include, but are not limited to, implement weight, dimensions, turning radius, tool characteristics, hitch characteristics, implement sensor characteristics, or implement actuator characteristics. In a similar manner, vehicle characteristics include, but are not limited to, vehicle dimensions, turning radius, engine characteristics, motor characteristics, transmission characteristics, ground engaging element spacing, hitch characteristics, vehicle sensor characteristics, or vehicle actuator characteristics. In some examples, these characteristics (e.g., characteristic bundles) are investigated by the autonomous assembly configurator, for instance through identification and collection of sensor or actuator capabilities, communication with a vehicle or implement memory, or the like by way of connection with the implement or vehicle by BUS, wirelessly or the like. Accordingly, input by an operator, downloading of files from the internet or USB drives or similar is not necessary. Instead, the configurator examines the vehicle, implement or the like and identifies and collects the capabilities (e.g., characteristics) as an example of receiving these characteristics. In other examples, the characteristics are logged in the configurator memory, downloaded from the vehicle or implement, internet or USB drive or the like and accessed by the configurator when an agricultural assembly of an agricultural vehicle, agricultural implement, or field is specified by the operator as another example of receiving the characteristics. Optionally, the characteristics are input by the operator as still another example of receiving the characteristics (e.g., typed, scanned from a bar code, selected in a user interface, or the like).

The configurator (e.g., one or more processors) generates an autonomous configuration profile for one or more autonomous operations according to the received characteristic bundles received as component bundles or a composite characteristic bundle with two or more component bundles. In one example, the configurator determines operation parameters for the autonomous agricultural operation based on the received characteristics for the field, vehicle and implement. For instance, the implement characteristic bundle including its dimensions, sensors, actuators or the like are used for generation of the parameters of the agricultural operation. In one example, a sprayer implement having a characteristic bundle of pump pressure and flow rate ranges, nozzle tip sizes, nozzle spacing, PWM control valve characteristics, and injectable herbicide for use with a base agricultural product of water and a base fertilizer is used by the autonomous agricultural assembly configurator, along with field characteristics, to generate the parameters for the autonomous operation. For instance, the determined operation parameters include flow rate, droplet size, pressure range, agricultural product application prescriptions (e.g., of base product and the injectable product) of flow rate and composition indexed to zones of a field. Optionally, values are specified for the parameters by the configurator such as specified flow rate, droplet size, pressure range, boom height or the like based on one or more of the field characteristics, implement characteristics; or operator input to the available parameters; or the like. Additionally, the configurator connects sensors, actuators or the like from the component vehicle and implement, previously received as characteristics by the configurator, with control instructions as operation parameters for the autonomous agricultural operation. For instance, the configurator selects sensors, actuators or the like that are available from the received characteristics and interconnects the input and control for those sensors and actuators to conduct the agricultural operation (e.g., driving, implement operation or the like).

Optionally, the configurator determines a path plan for the autonomous agricultural operation based on the received field characteristic bundle along with the implement characteristic bundle. In one example, the vehicle characteristic bundle is used in combination with the field and implement characteristic bundles to determine the path plan. For instance, speed ranges, transmission, ground engaging element spacing, swath width, and turning radii facilitate determination of a corresponding path plan based on the received one or more vehicle or implement characteristic bundles.

The autonomous configuration profile is generated by the configurator based on received characteristics (e.g., characteristic bundles, including composite characteristic bundles) for a specified field, specified agricultural implement, and specified agricultural vehicle, for instance selected by a farmer having a garage of implements and vehicles, as well as various fields that require differing agricultural operations. The operator specifies a combination of a field, implement and vehicle and the autonomous agricultural assembly configurator generates the profile for the autonomous operation based on one or more of the specified field, implement or vehicle and the associated characteristics of each. This contrasts with other example vehicle and implement controllers having controller templates and associated autonomous agricultural operations that are developed for a vehicle model, implement or the like and accordingly are based on the set up of characteristics for the specified vehicle model or specified implement model.

The configurator (e.g., a processor remote to the agricultural assembly or onboard the assembly) is distinct from the onboard controller of the agricultural vehicle and the controller for the agricultural implement. In an example, the configurator (and its own associated controller) is in communication with these controllers but physically distinct. In another example, the configurator is a component (e.g., instructions in a computer readable medium) installed to a processor associated with the agricultural vehicle or the agricultural implement, such as a field computer.

Because the autonomous agricultural assembly configurator is distinct from the controllers of the vehicle and the implement the configurator readily cooperates with the distinct controllers, component sensors, component actuators or the like to provide an autonomy platform that seamlessly works with a variety of vehicles and implements having varied capabilities. For example, an existing autonomy platform having an existing control template associated with an original equipment manufacturer (OEM) or controller developer is bypassed or cooperatively used by the configurator. The autonomous agricultural assembly configurator interfaces with the agricultural vehicle, agricultural implement or the like including the sensors, actuators and other capabilities or functions to generate its own autonomous operation based on the characteristic bundles of the vehicle, implement and specified field. For instance, the configurator receives characteristics corresponding to sensors, actuators, capabilities or the like of one or both of the vehicle and implement and generates the autonomous configuration profile for an autonomous operation based on those characteristics (as well as the field characteristics) that is distinct from existing autonomous operations provided by existing controllers having control templates that are developed for the specific vehicle or implement. In one example, the configurator selects sensors, actuators, engines, motors, tools or the like of the component vehicle and implement that are available from the received characteristics and interconnects the input and control for those sensors, actuators or the like to conduct the agricultural operation (e.g., driving, implement operation or the like). This interface of the configurator with each of the vehicle and implement permits the seamless integration of vehicles and implements and generation of flexible autonomous operation profiles based on varied capabilities of the vehicles and implements despite variations in manufacturer or combination of vehicle and implement that may otherwise interfere or frustrate autonomous operation.

Additionally, the autonomous agricultural assembly configurator permits customization and refinement of autonomous operation in a flexible manner for an operator. For instance, as discussed herein previous autonomous vehicles, implements or the like have developer generated autonomous operations (e.g., control templates) that are married to the vehicle controller, implement controller or the like. For example, an agricultural vehicle includes a field computer that optionally includes a vehicle based autonomy controller developed for that vehicle that permits the input of a path plan and may (absent compatibility issues) connect with an implement controller of the agricultural implement or conduct its own control of the agricultural implement. The developer generated autonomous operations are configured for the resident vehicle (e.g., are based on its control template), are specifically based on the capabilities of that vehicle, and accordingly provide a limited basis for customization or refinement of the autonomous operation.

In contrast, the autonomous agricultural assembly configurator interfaces with the agricultural vehicle and agricultural implement in the manner of an operator, such as a driver, having access to and command of the varied capabilities of each of the vehicle and the implement such as sensors, actuators, implement tools, engines, motors or the like. The configurator in some examples, also interfaces with controllers of the vehicle and the implement, however the configurator also provides accessibility to one or both of the vehicle and implement capabilities such as sensors, actuators, tools, engines, motors or the like. This accessibility provides an interface for the operator to generate routines, refine an agricultural operation, or vary one or more aspects of the agricultural operation, and provides a level of customization to autonomous control of an agricultural assembly of a vehicle and implement that is absent in other example autonomous controllers having developer generated control templates.

For example, as discussed herein the autonomous agricultural assembly configurator generates an autonomous configuration profile for an autonomous operation including operation parameters and optionally a path plan (in some examples the path plan is provided by another processor, for instance associated with the field map, remote server or the like). The configurator also provides operator access to the sensors, actuators, implements tools, engines, motors or the like of one or both of the vehicle or implement. Accordingly, in one example the generated autonomous configuration profile is for a sprayer autonomous operation optionally including a path plan for the agricultural assembly of a sprayer (chassis and spray booms) as well as operation parameters including, but not limited to, sprayer flow rate, sprayer pressure, agricultural product composition, boom height, droplet size, chassis speed, chassis turn speed, indexed obstacle routines or the like. The configurator further permits the operator to customize, refine, modify, or vary the autonomous configuration profile with routines, refinements or the like generated with the configuration.

In one example, with the example sprayer autonomous configuration profile, the operator provides one or more operation refinements. In a first example, the operator specifies a refinement to the end of row turning for the sprayer autonomous configuration profile. The autonomous agricultural assembly configurator is interfaced with the sensors, actuators, engines, motors, tools or the like of one or more of the vehicle and the implement. In this example, an end of row operation refinement to reduce sprayer boom moment and stress during a turn is generated with the configurator by the operator. One or both of vision or GPS sensors for the vehicle are selected, a threshold is added that corresponds to determination of an end of row while conducting a sprayer operation along swaths of the path plan of the base sprayer autonomous configuration profile, and achieving of that threshold is interconnected with the sprayer boom actuators to trigger elevation of the sprayer booms to a stowed position, such as a “middle position” (relative to “fully extended” and “in” positions) while the sprayer conducts an end of row turn. The operation refinement further includes selection of the vision or GPS sensors and a threshold that corresponds to determination of arrival at a next swath of the path plan. Achieving that threshold is interconnected with the spray boom actuators to trigger lowering of the sprayer booms to a “fully extended” position with the boom height provided with the sprayer autonomous configuration profile. The operation refinement is then included with the sprayer autonomous configuration profile, and upon a detected arrival or approach for an end of a swath (row) the operation refinement is implemented with a controller associated with the autonomous agricultural assembly configurator, or optionally with controllers associated with one or more of the agricultural vehicle or agricultural implement and interconnected with the configurator.

In another example, the autonomous agricultural assembly configurator generates an autonomous configuration profile for a cultivation agricultural operation using a tractor as the agricultural vehicle and a cultivator as the agricultural implement, for instance from different or the same OEMs. The operator specifies a refinement to cultivator operation for in-row turns (in contrast to straight segments of a swath) to minimize engagement of the cultivator tool with the root systems of crops. The autonomous agricultural assembly configurator is interfaced with the sensors, actuators or the like of one or more of the tractor and the cultivator. For instance, the curvature (radius) of a crop row or path plan is monitored with one or both of tractor vision sensors, monitoring of the path plant curvature (e.g., row curvature) or the like. A threshold is added for turn radii of 15 feet or less. Achieving that threshold is interconnected with one or both of autonomous steering, cultivator knife orientation or position actuators or similar. Autonomous steering or cultivator knife orientation/steering is conducted to guide the cultivator knives 10 inches away from crops along an inside of the turn. Alternatively, a keep out zone, exclusion zone or the like for the crops is expanded (e.g., to 10 inches) to trigger tighter autonomous control of the cultivator knife positions away from the crops (e.g., between crop rows). Additionally, the tractor engine is controlled to with a target speed threshold 3 miles per hour less than a base target speed threshold. In another example, cultivator knife depth is decreased from an operation profile setting to minimize crop root engagement. A second threshold is added for turn radii of greater than 15 feet to suspend the enhanced steering control or knife positions or the expanded exclusion zone and to re-institute the base target speed threshold.

The operation refinement examples described herein, and their equivalents, are permitted because of the accessibility to the sensors, actuators, implement tools, engines, motors or the like of one or both of the vehicle or implement that is provided through the configurator. In previous controllers, access to these features was concealed within developer generated autonomous operation control templates, controllers or the like. To access these features a developer, coder or the like opens source code for the autonomous operation, writes a new routine, tests and debugs, and then adds the routine to the autonomous operation. If the routine requires cooperation between a vehicle and an implement, developer teams for both the vehicle and implement meet and cooperatively develop the new routine over a period of time (e.g., days, months or longer). In practice, this editing of an autonomous operation is done through intermittent updates by the developer such as firmware or software updates. Accordingly, an operator does not have ready access to the full capabilities of each of the agricultural vehicle and the agricultural implement.

The autonomous agricultural assembly configurator provides access to a range of capabilities of an agricultural vehicle and agricultural implement, and permits the ready generation of autonomous operations and operation refinements that are easily included with the autonomous configuration profile generated with the configurator and carried out with a controller. The autonomous operation and operation refinements thereof are not constrained by developer based controller architecture, autonomous operation templates or the like. Accordingly, the autonomous agricultural assembly configurator permits the generation of autonomous operation profiles and operation refinements using the full capabilities of the vehicle and implement including sensors, actuators or the like alone or cooperatively between vehicle and implement, and in permutations specified by the operator (e.g., in contrast to specifications of developer-based autonomous operation).

Further, the autonomous agricultural assembly configurator is not developer specific. Instead, the configurator interfaces with and receives the characteristics for a selected vehicle and a selected implement (or combination vehicle and implement) including interfacing with the functional capabilities of the vehicle and implement, such as sensors, actuators, throttles, engines, motors, implement tools or the like. Accordingly, the configurator has access to these capabilities and generates autonomous configuration profiles with the sensors, actuators or the like available for a selected vehicle and a selected implement, irrespective of manufacturer, proprietary controller and associated control template or the like. An operator, such as a farmer, having a garage of available agricultural vehicles, implements or the like may freely select vehicles and implements as desired for an agricultural assembly and then generate an autonomous configuration profile and operation refinements for the agricultural assembly even with vehicles and implements having different OEMs, developers or the like. Further still, the operator is not prohibited from purchasing additional implements, vehicles or the like that are newer models (or in some cases older models), have a different manufacturer or developer or the like. The autonomous agricultural assembly configurator interfaces with the capabilities of vehicles and implements (e.g., sensors, actuators or the like), and thereby provides a flexible mechanism for the generation and implementation of autonomous configuration profiles and operation refinements.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of one example of an autonomous control system for an agricultural assembly.

FIG. 2A is a schematic view of one example of an agricultural vehicle, an associated vehicle controller, and associated vehicle sensors and actuators.

FIG. 2B is a schematic view of a second example of an agricultural vehicle, an associated vehicle and implement controller, and associated vehicle and implement sensors and actuators.

FIG. 2C is a schematic view of a third example of an agricultural vehicle, an associated vehicle and implement controller, and associated vehicle and implement sensors and actuators.

FIG. 2D is a schematic view of one example of an agricultural implement, an associated implement controller, and associated implement sensors and actuators.

FIG. 2E is a schematic view of a second example of an agricultural implement, an associated implement controller, and associated implement sensors and actuators.

FIG. 2F is a schematic view of a third example of an agricultural implement, an associated implement controller, and associated implement sensors and actuators.

FIG. 3 is a view of an example field and associated field characteristics.

FIG. 4 is a schematic diagram of one example of an autonomous agricultural assembly configurator and controller in communication with an agricultural vehicle and an agricultural implement.

FIG. 5 is a block diagram of the generation of an autonomous configuration profile.

FIG. 6 is a schematic diagram of one example of an operation refinement generator in communication with the remainder of the autonomous agricultural assembly configurator and controller shown in FIG. 4.

FIG. 7 is a collection of an autonomous operation profile and example operation refinements for an agricultural sprayer autonomous spraying operation.

FIG. 8 is a collection of an autonomous operation profile and example operation refinement for an agricultural tillage operation.

FIG. 9 is a block diagram showing one example of a machine configured to perform one or more of the methods described herein.

### DETAILED DESCRIPTION

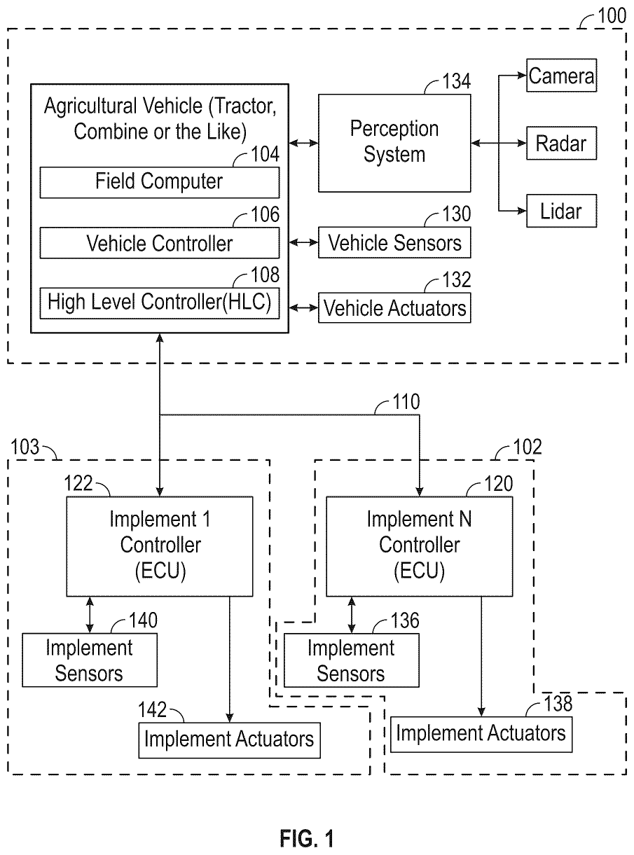

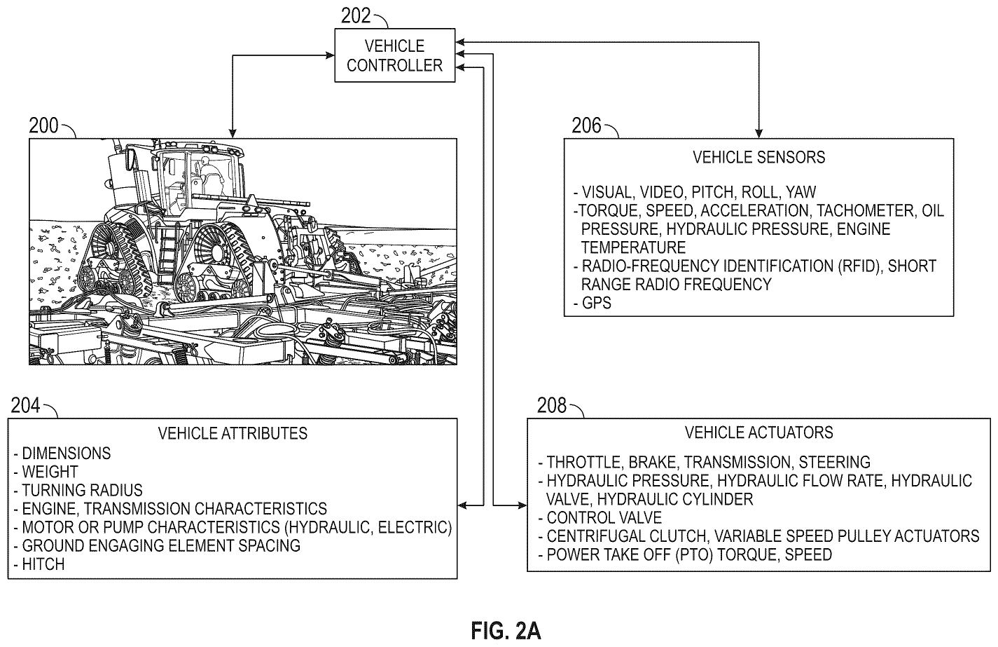

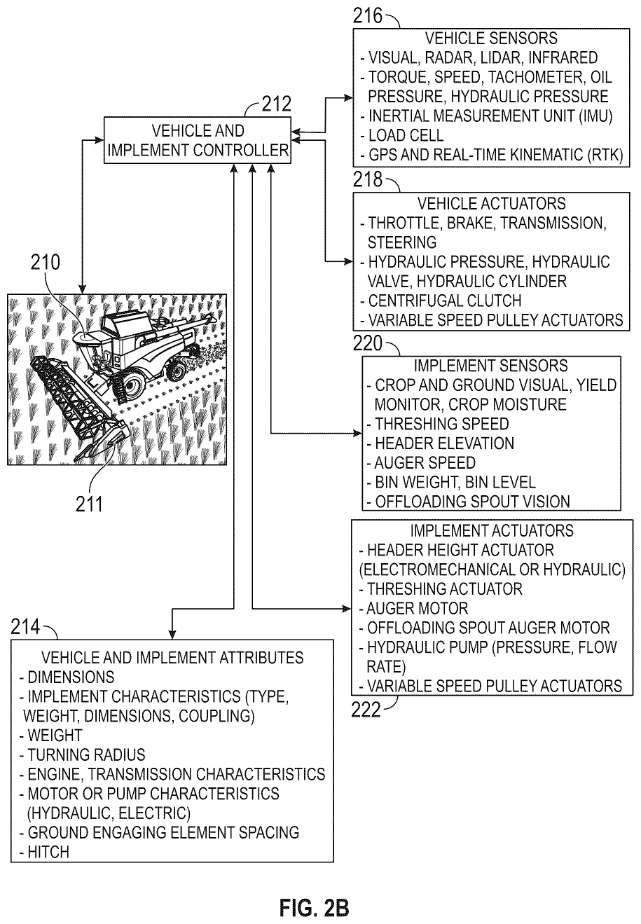

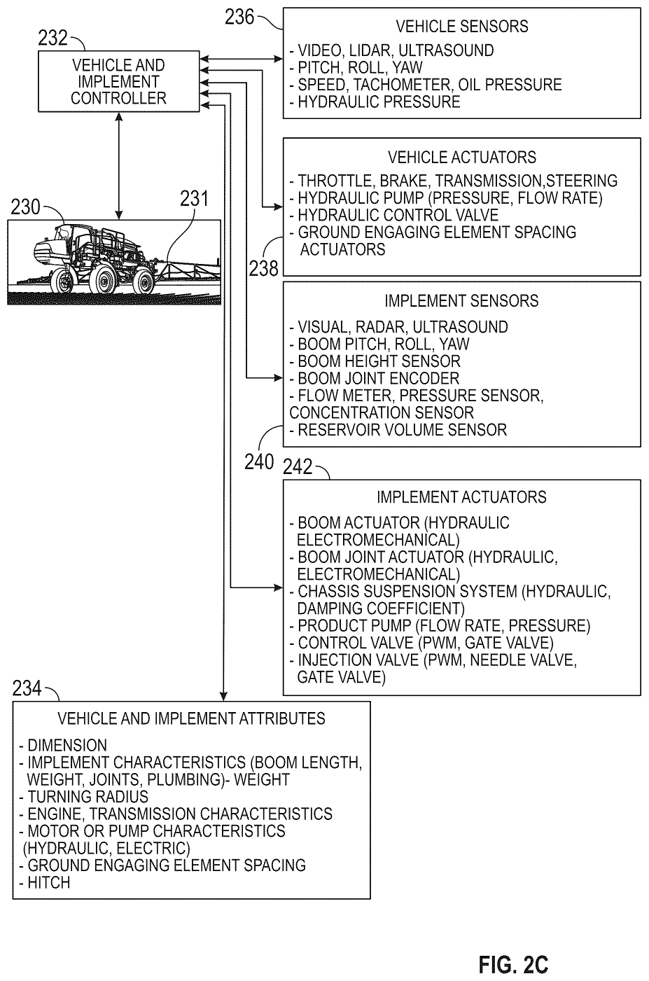

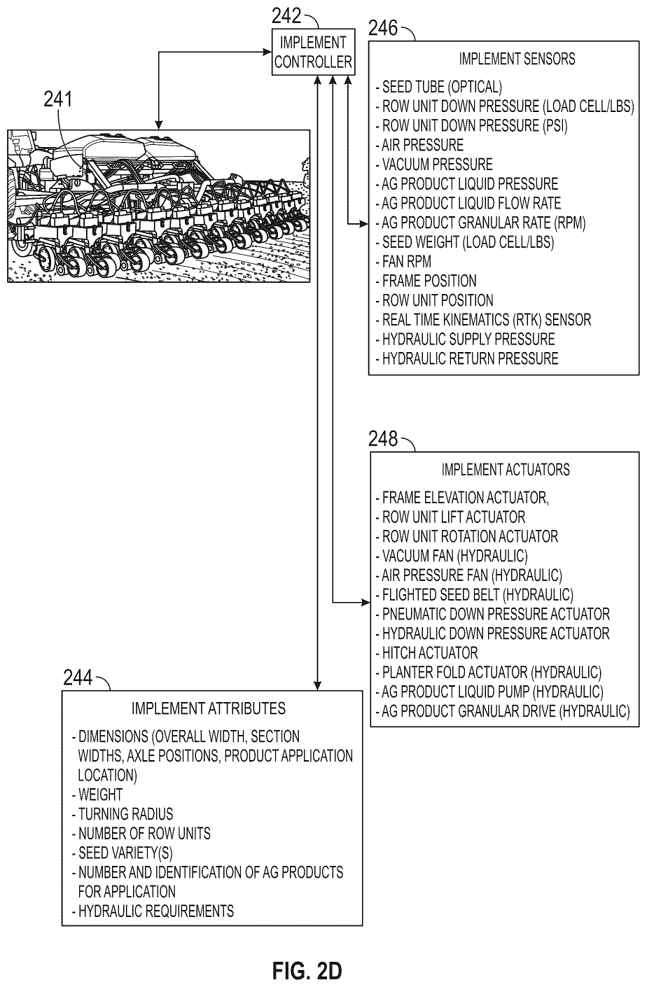

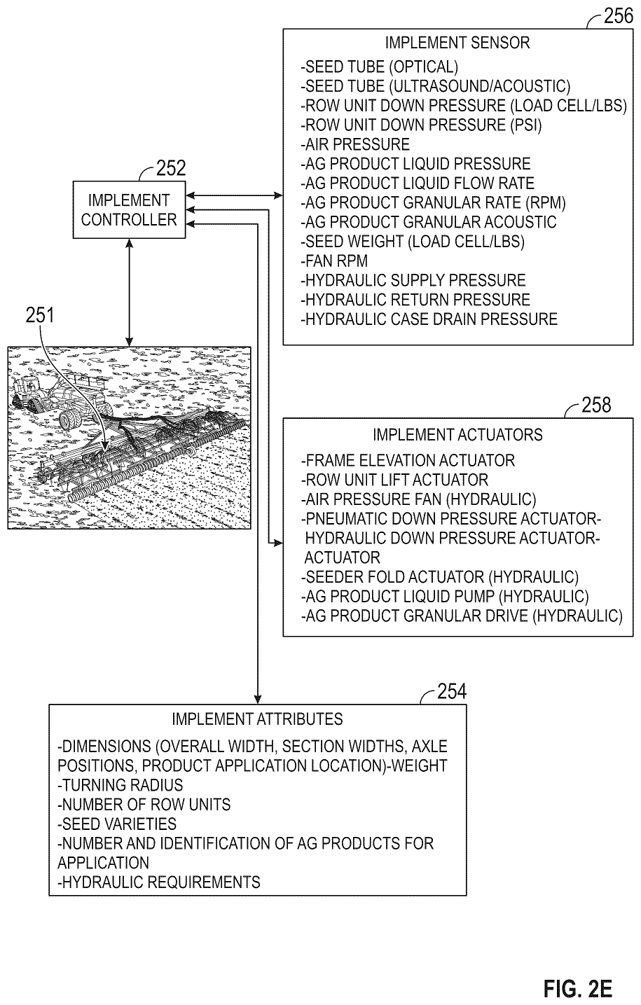

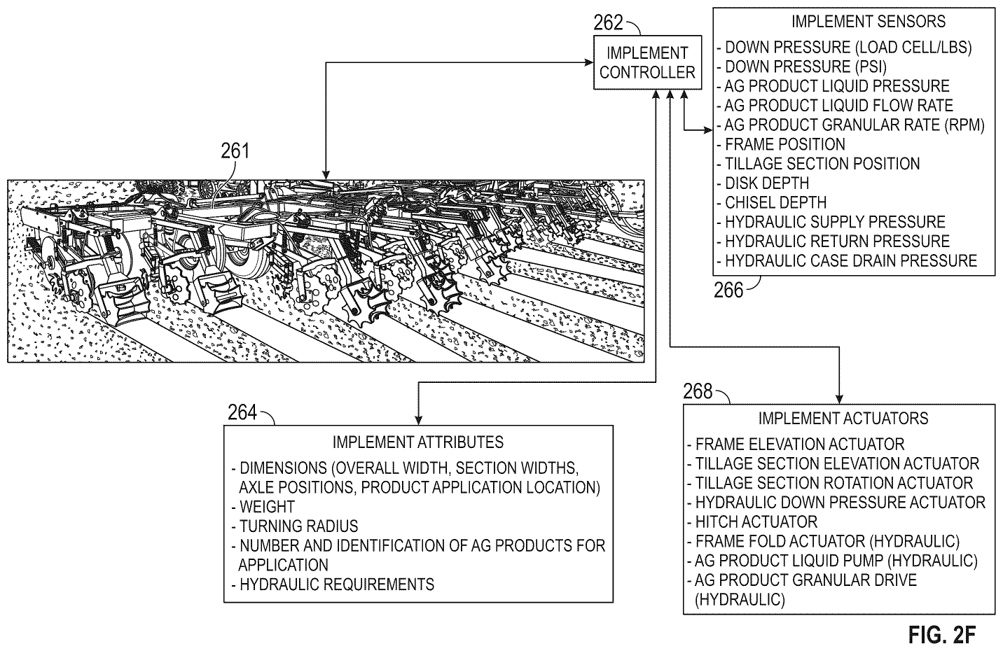

FIG. 1 is a block diagram illustrating an example agricultural vehicle 100 and associated implements 102, 103. The connected vehicle 100 and one or more of the implements 102, 103 are described herein as an agricultural assembly. The agricultural vehicle 100 includes a prime mover such as a tractor, combine, or the like. In various examples, agricultural vehicles, including the vehicle 100, each have an associated combination of sensors, actuators, tools, capabilities, dimensions or the like referred to herein as characteristics and, when collected together, characteristic bundles that are representative of features and functions of the agricultural vehicles. These characteristics and characteristic bundles accordingly vary based on the vehicle 100 type, OEM, model, model year, options selected at purchase, aftermarket installed features, or the like. These characteristics and associated characteristic bundles are described herein (e.g., see FIGS. 2A-2F).

Referring again to FIG. 1, in this example the agricultural vehicle 100 includes a field computer 104. The field computer 104, in various examples, includes information about one or more fields (an example of characteristics and characteristic bundles), such as but not limited to, field boundaries, crops, row spacing, zone prescriptions, indexed obstacles or the like.

As further shown in FIG. 1, the agricultural vehicle 100 includes a vehicle controller 106, such as one or more onboard controllers that are developed and tailored to the capabilities of the vehicle. For instance, the vehicle controller 106 is developed to work with the sensors and actuators included with the vehicle (e.g., during vehicle design and production). In one example, the vehicle controller 106 implements a developed control template that is based on the capabilities of the vehicle and, optionally, capabilities of compatible implements for instance from the same OEM. In other examples, the vehicle controller 106 provides autonomous (including semi-autonomous) driving functionality.

In another example, the agricultural vehicle 100 includes a high level controller 108 that handles higher priority operations, for instance related to safety. The high level controller is in communication with one or more of a perception system 134, vehicle sensors 130, or vehicle actuators 132 of the vehicle 100. Examples of vehicle sensors 130, vehicle actuators 132, or the like are provided herein. Optionally, the perception system 134 is interconnected with one or more the vehicle sensors 130, such as cameras, radar, lidar or the like to permit monitoring and identification of obstacles. For instance, the perception system 134 includes one or more of machine learning or artificial intelligence algorithms to identify and index obstacles from observations conducted with the vehicle sensors 130. The high level controller 108, in one example, accesses priority identified obstacles (e.g., humans or livestock) and is configured to take immediate action. For example, an observed human within 50 feet prompts the high level controller 108 to override operation and halt operation of the vehicle 100 otherwise implemented with the vehicle controller 106. In another example, if livestock or an obstacle having one or more dimensions above a dimensional threshold is detected along a planned path the high level controller 108 halts operations or optionally redirects the vehicle 100 around the obstacle.

Referring again to FIG. 1, example agricultural implements 102, 103 are shown. The agricultural implements 102, 103 include, but are not limited to, harvester heads, sprayer booms, cultivators, spreaders, seeders, planters, mowers, balers, grain carts, or the like. Each of the implements 102, 103 has a distinct combination of one or more of sensors, actuators, tools, capabilities, dimensions or the like referred to herein as implement characteristics and, when collected together, characteristic bundles are representations of the features and functions of the implements 102, 103. These characteristics and characteristic bundles accordingly vary based on the implement 102, 103 type, OEM, model, model year, options selected at purchase, aftermarket installed features, or the like. These characteristics and associated characteristic bundles are described herein (e.g., see FIGS. 2B-2F).

In one example, one or both of the implements 102, 103 include respective implement controllers 120, 122. The implement controllers 120, 122 are one or more electronic control units that monitor and operate the implements 102, 103. For instance, the implement controller 120 receives information from the associated implement sensors 136 and provides instructions to the implement actuators 138 for controlling the implement actuators 138 of the implement 102 during an agricultural operation. In another example, the implement controller 122 of the implement 103 is interconnected with the implement sensors 140 and implement actuators 142, and the controller 122 receives information of the implement sensors 140 and conducts control of the implement 103. In a similar manner to the agricultural vehicle 100, in various examples, the implement controllers 120, 122 include existing control templates developed for the capabilities of the respective implement (e.g., during implement design and construction). Optionally, the implement controllers 120, 122 are identified as lower priority controllers in comparison to the vehicle controller 106 and high level controller 108 thereby permitting the controllers 106, 108 to override implementation of control by the implement controllers 120, 122, for instance in a conflicting control circumstance.

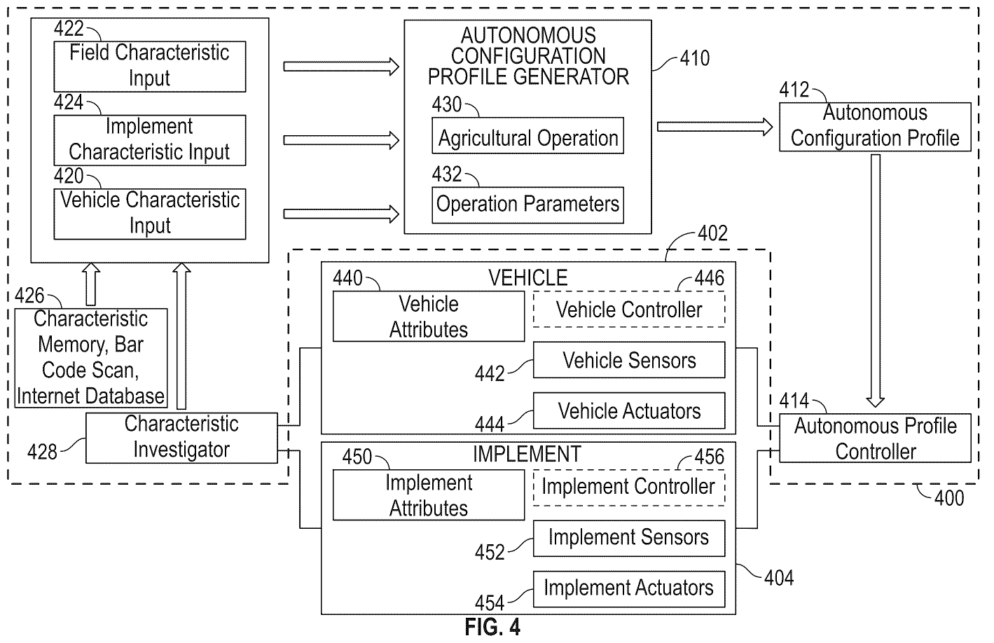

As discussed herein, the agricultural vehicle 100, implements 102, 103, or the like are cooperatively interconnected with an autonomous agricultural assembly configurator (and optional controller) 400, as shown in FIG. 4. The autonomous agricultural assembly configurator (referred to as the configurator in some places herein) receives the capabilities of the vehicle 100 and implements 102, 103 as specified by the operator and generates an autonomous configuration profile (e.g., in situ) based on those respective capabilities. For instance, combinations of two or more of the vehicle sensors and actuators 130, 132; other vehicle characteristics (dimensions, turning radius, or the like), implement sensors and actuators 136, 138 or 140, 142, other implement characteristics or the like are input to the configurator 400 and the configurator generates an autonomous configuration profile (412 in FIG. 4). The autonomous configuration profile 412 is constructed from the received information and operator specifications (e.g., specified speed or speed range, flow rate or range, pressure or pressure range, header height, specified cultivator coulter depth, or the like) and leverages the capabilities of the specified vehicle 100 and specified implement 102, 103. The autonomous configuration profile 412 is implemented by the vehicle and implement controllers (446, 456 in FIG. 4) to conduct the autonomous agricultural operation. Optionally, the configurator 400 includes an autonomous profile controller 414 to permit the configurator 400 to implement control of the specified vehicle 100 and selected implement 102, 103, for instance through instruction of the associated controllers 446, 456 or direct interaction with the vehicle sensors and actuators 442, 444 and the implement sensors 452, 454. The configurator 400 is described herein. Examples of agricultural vehicles and implements having varying capabilities (e.g., characteristics and collective characteristic bundles) are shown in FIGS. 2A-2E.

FIG. 2A shows one example of an agricultural vehicle 200. In this example, the vehicle 200 is a prime mover, such as a tractor having associated attributes 204, vehicle sensors 206 and vehicle actuators 208, referred to as characteristics and, collectively, as characteristic bundles. For example, the example agricultural vehicle 200 includes a permutation of characteristics such as dimensions, turning radius, or the like (attributes 204); sensors (206); and actuators (208) that are specific to its make, model, year, buyer selected options or the like. Accordingly, each permutation of the vehicle 200 potentially includes a variety of differing characteristic bundles that correspondingly provide variations in capabilities and functionality of the vehicle 200. For instance, even among models of the same vehicle 200 one or more characteristics may vary extensively. For example, optional sensors and actuators are included in some but not all models; a model uses tracks instead of wheels; has different hydraulic capabilities; varies by one or more of weight or dimensions because of options selected or the like, all of which vary the characteristic bundle of the vehicle 200 relative to other example vehicles 200.

As further shown in this example, the agricultural vehicle 200 includes a vehicle controller 202. The vehicle controller 202 is in communication with the vehicle sensors 206 and vehicle actuators 208 that facilitate operation of the vehicle. In some examples, the vehicle controller 202 includes autonomous operation capabilities including autonomous driving, for instance according to a path plan provided by a field computer, remote server or the like. In another example, the vehicle controller 202 is a proprietary controller that is developed and configured to work with the sensors 206, actuators 208, and attributes 204 of the present vehicle. Access to the sensors 206 and actuators 208 and use of the same is in some examples buried behind the vehicle controller 202 and frustrated by the proprietary controller controlling or precluding access to the sensors and actuators.

Referring again to FIG. 2A, with this example agricultural vehicle 200 (tractor) example vehicle attributes 204 include, but are not limited to, vehicle dimensions, weight, turning radius, engine characteristics, transmission characteristics, motor or pump characteristics (hydraulic, electric, or the like), ground engaging element type (wheels, tracks, or the like) and spacing, hitch type. As discussed herein, the vehicle attributes 204 are received by an autonomous configuration profile generator 410 of the configurator 400 to permit construction of the autonomous configuration profile 412 of an autonomous operation based in part on those attributes 204.

The vehicle 200 further includes various sensors 206 that include one or more of, but are not limited to, vision type sensors (e.g., camera, video camera, radar, lidar, or the like); pitch, roll, yaw sensors; torque; speed, acceleration; tachometer; oil pressure; hydraulic pressure, flow rate; engine temperature; radio-frequency identification (RFID); short range radio transceiver; cellular transceiver; global positioning satellite (GPS), real time kinematic (RTK) sensors; or the like. The vehicle sensors 206, characteristics of the sensors, or the like are received by the autonomous configuration profile generator 410, and the generator 410 constructs the autonomous configuration profile 412 based on the vehicle sensors 206 available, for instance to facilitate autonomous driving, monitoring of the vehicle 200 (e.g., position, pitch, yaw, roll, angle relative to a crop row or guidance line, torque, rpms, speed or the like), monitoring of a proximate implement (102, 103), or the like.

The vehicle 200 also includes the various actuators 208, such as one or more of, but not limited to, throttle, brake, transmission, steering; hydraulic pressure, hydraulic flow rate, hydraulic valve, hydraulic cylinder; control valve; centrifugal clutch; variable speed pulley actuators; power take off (PTO) torque; speed actuators or the like. The vehicle actuators 208, characteristics of the actuators, or the like are received by the autonomous configuration profile generator 410, and the generator 410 constructs the autonomous configuration profile 412 based on the vehicle actuators 208 available, for instance to facilitate autonomous driving, operation of the vehicle 200 (e.g., PTO output, hydraulic pressure, hydraulic flow rate, or the like), or the like.

FIG. 2B shows one example of an agricultural vehicle 200. In this example, the vehicle 210 is a combine having an associated agricultural implement 211, such as a harvester head. The agricultural vehicle 200 has attributes 204, and includes vehicle sensors and actuators 206, 208 as well as implement sensors and actuators 220, 222, referred to as characteristics and, collectively, as characteristic bundles. For example, the example agricultural vehicle 210 includes a permutation of characteristics such as dimensions, turning radius, or the like (attributes 214); sensors (216, 220); and actuators (208, 222) that are specific to its make, model, year, buyer selected options or the like. Accordingly, each permutation of the vehicle 210 potentially includes a variety of differing characteristic bundles that correspondingly provide variations in capabilities and functionality of the vehicle 210 relative to other combines and relative to other example vehicles, such as the tractor shown in FIG. 2A (vehicle 200). For instance, even among models of the same vehicle 210 one or more characteristics may vary, sometimes extensively. For example, optional sensors and actuators are included in some but not all models; a model uses tracks instead of wheels; has a different harvester head (implement 211); varies by one or more of weight or dimensions because of options selected or the like, all of which vary the characteristic bundle of the vehicle 210 relative to other example vehicles 200 or 210.

As further shown in this example, the agricultural vehicle 210 includes a vehicle and implement controller 212. The vehicle and implement controller 212 is in communication with the vehicle sensors and actuators 206, 208 and implement sensors and actuators 218, 222 that facilitate operation of the vehicle and the associated implement 211. In some examples, the vehicle and implement controller 212 includes autonomous operation capabilities including autonomous driving, for instance according to a path plan provided by a field computer, remote server or the like. In another example, the vehicle controller 212 is a proprietary controller that is developed and configured to work with the sensors 216, 220 and actuators 218, 222 and attributes 214 of the present vehicle. Access to the sensors 216, 220 and actuators 218, 222 and use of the same is in some examples buried behind the vehicle and implement controller 212 and frustrated by the proprietary controller controlling or precluding access to the sensors and actuators. As described herein, the autonomous agricultural assembly configurator 400 interfaces with one or more of the vehicle controller 212, sensors 216, 220, or actuators 218, 222 to access the capabilities of the vehicle 210 and implement 211.

Referring again to FIG. 2B, with this example agricultural vehicle 210 (combine) example vehicle and implement attributes 214 include, but are not limited to, dimensions, implement characteristics (type, weight, dimensions, coupling with the vehicle), weight, turning radius, engine and transmission characteristics, motor or pump characteristics (hydraulic, electric, or the like), ground engaging element type and spacing, hitch type. As discussed herein, the vehicle attributes 214 are received by the autonomous configuration profile generator 410 of the configurator 400 to permit construction of the autonomous configuration profile 412 of an autonomous operation based in part on those attributes 214, such as a harvesting operation.

The vehicle 210 further includes various sensors 216 that include one or more of, but are not limited to, vision type sensors (e.g., visual, radar, LiDAR, infrared); torque, speed, tachometer, oil pressure, hydraulic pressure; inertial measurement unit (IMU); load cell; one or more of GPS or RTK; or the like. The vehicle sensors 216, characteristics of the sensors, or the like are received by the autonomous configuration profile generator 410, and the generator 410 constructs the autonomous configuration profile 412 based on the vehicle sensors 216 available, for instance to facilitate autonomous driving, monitoring of the vehicle 210 (e.g., position, pitch, yaw, roll, angle relative to a crop row or guidance line, torque, rpms, speed or the like), monitoring of the associated implement 211, or the like.

The vehicle 210 also includes the various actuators 218, such as one or more of, but not limited to, throttle, brake, transmission, steering; hydraulic pressure, hydraulic valve, hydraulic cylinder; centrifugal clutch; variable speed pulley actuators; or the like. The vehicle actuators 218, characteristics of the actuators, or the like are received by the autonomous configuration profile generator 410, and the generator 410 constructs the autonomous configuration profile 412 based on the vehicle actuators 218 available, for instance to facilitate autonomous driving, operation of the vehicle 210 (e.g., engine output directed to the implement 211, hydraulic pressure, hydraulic flow rate, or the like), or the like.

In a similar, though not identical, manner to the vehicle sensors and actuators 216, 218 the example vehicle 210 and its associated implement 211 (e.g., a harvester head and associated agricultural operation mechanism, such as a belt, auger, or the like) include implement sensors and actuators 220, 222 that permit monitoring and control of the implement 211. The implement sensors 220 include one or more of, but are not limited to, crop and ground vision sensors; yield monitor; crop moisture; threshing speed; header elevation (e.g., encoders); auger speed; bin weight, bin level; offloading spout (auger) vision; or the like. The implement actuators 222 include one or more of, but are not limited to, header height actuators (electromechanical or hydraulic); threshing actuators; auger motor; belt motor; offloading spout auger motor; hydraulic pump (pressure, flow rate); variable speed pulley actuators; or the like. The implement sensors 220 and actuators 222, characteristics of the sensors or actuators, or the like are received by the autonomous configuration profile generator 410, and the generator 410 constructs the autonomous configuration profile 412 based on these sensors 220 and actuators 222, for instance to facilitate autonomous operation of the implement 211 (e.g., header height, threshing speed, belt speed, auger speed, filling of a grain bin), or the like.

FIG. 2C shows another example of an agricultural vehicle 230. In this example, the vehicle 230 is an agricultural sprayer having an associated agricultural implement 231, such as a sprayer system including one or more sprayer booms, boom suspension system, agricultural product reservoirs, associated plumbing, and spray nozzles provided along the sprayer booms. The agricultural vehicle 230 has attributes 234, and includes vehicle sensors and actuators 236, 238 as well as implement sensors and actuators 240, 242, referred to as characteristics and, collectively, as characteristic bundles. For example, the example agricultural vehicle 230 includes a permutation of characteristics such as dimensions, turning radius, or the like (attributes 214); sensors (236, 238); and actuators (240, 242) that are specific to its make, model, year, buyer selected options or the like. Accordingly, each permutation of the vehicle 230 potentially includes a variety of differing characteristic bundles that correspondingly provide variations in capabilities and functionality of the vehicle 230 relative to other agricultural sprayers and relative to other example vehicles, such as the vehicles shown in other figures herein and their equivalents.

As further shown in this example, the agricultural vehicle 230 includes a vehicle and implement controller 232. The vehicle and implement controller 232 is in communication with the vehicle sensors and actuators 236, 238 and implement sensors and actuators 240, 242 that facilitate operation of the vehicle 230 and the associated implement 231. In some examples, the vehicle and implement controller 232 includes autonomous operation capabilities including autonomous driving, for instance according to a path plan provided by a field computer, remote server or the like. In another example, the vehicle and implement controller 232 is a proprietary controller that is developed and configured to work with the sensors 236, 240 and actuators 238, 242 and attributes 234 of the present vehicle. Access to the sensors 236, 240 and actuators 238, 242 and use of the same is in some examples buried behind the vehicle controller 232 and frustrated by the proprietary controller controlling or precluding access to the sensors and actuators. As described herein, the autonomous agricultural assembly configurator 400 interfaces with one or more of the vehicle controller 232, sensors 236, 240, or actuators 238, 242 to access the capabilities of the vehicle 230 and implement 231.

Referring again to FIG. 2C, with this example agricultural vehicle 230 (sprayer) example vehicle and implement attributes 234 include, but are not limited to, dimensions, implement characteristics (type, weight, dimensions, coupling with the vehicle), weight, turning radius, engine and transmission characteristics, motor or pump characteristics (hydraulic, electric, or the like), ground engaging element type and spacing, hitch type. As discussed herein, the vehicle attributes 234 are received by the autonomous configuration profile generator 410 of the configurator 400 to permit construction of the autonomous configuration profile 412 of an autonomous operation based in part on those attributes 234, such as an agricultural spraying operation.

The vehicle 230 further includes various sensors 236 that include one or more of, but are not limited to, vision type sensors (e.g., visual, radar, LiDAR, infrared, ultrasound); pitch, yaw, roll; torque, speed, tachometer, oil pressure, hydraulic pressure; inertial measurement unit (IMU); load cell; one or more of GPS or RTK; or the like. The vehicle sensors 236, characteristics of the sensors, or the like are received by the autonomous configuration profile generator 410, and the generator 410 constructs the autonomous configuration profile 412 based on the vehicle sensors 236 available, for instance to facilitate autonomous driving, monitoring of the vehicle 230 (e.g., position, pitch, yaw, roll, angle relative to a crop row or guidance line, torque, rpms, speed or the like), monitoring of the associated implement 231, or the like.

The vehicle 230 also includes the various actuators 238, such as one or more of, but not limited to, throttle, brake, transmission, steering; hydraulic pressure, hydraulic valve, hydraulic cylinder; ground engaging element spacing actuators; or the like. The vehicle actuators 238, characteristics of the actuators, or the like are received by the autonomous configuration profile generator 410, and the generator 410 constructs the autonomous configuration profile 412 based on the vehicle actuators 238 available, for instance to facilitate autonomous driving, operation of the vehicle 230 (e.g., engine output directed to the implement 231, hydraulic pressure, hydraulic flow rate, or the like), or the like.

In a similar, though not identical, manner to the vehicle sensors and actuators 236, 238 the example vehicle 230 and its associated implement 231 (e.g., a spraying system) include implement sensors and actuators 240, 242 that permit monitoring and control of the implement 231. The implement sensors 240 include one or more of, but are not limited to, vision sensors such as, cameras, video cameras, radar, lidar, ultrasound; boom pitch, roll, yaw; boom height sensors; boom joint encoders (e.g., to measure boom positions and angles); flow meters, pressure sensors; concentration or constitution sensors to monitor an agricultural product; reservoir volume sensors; or the like. The implement actuators 242 include one or more of, but are not limited to, boom actuator (hydraulic, electromechanical), boom joint actuator (hydraulic, electromechanical); chassis suspension system (hydraulic, damping coefficient); agricultural product pumps (flow rate, pressure); control valves (PWM, gate valve); injection valves (PWM, needle valve, gate valve) for concentration and constitution management of the agricultural product; or the like. The implement sensors 240 and actuators 242, characteristics of the sensors or actuators, or the like are received by the autonomous configuration profile generator 410, and the generator 410 constructs the autonomous configuration profile 412 based on these sensors 240 and actuators 242, for instance to facilitate autonomous operation of the implement 231 (e.g., boom height, flow rate, independent control of nozzle flow rates, nozzle orifice sizes, one or both of agricultural product concentration or constitution), or the like.

FIG. 2D shows an example agricultural implement 241. In this example, the implement 241 is a planter, including a plurality of row units, seed hoppers, coulters, disks or the like provided along a tool bar. The agricultural implement 241 has attributes 244, and includes implement sensors and actuators 246, 248, referred to as characteristics and, collectively, as characteristic bundles. The example agricultural implement 241 includes a permutation of characteristics such as dimensions, turning radius, or the like (attributes 244); and sensors (240, 242) that are specific to its make, model, year, buyer selected options or the like. For instance, optional sensors and actuators are included in some but not all models; a model uses seed belt or gravity drop for seeds; different capabilities are provided with regard to liquid agricultural product application, granular agricultural product application or the like; or high resolution sensors, like RTK sensors, are included for higher resolution indexing of planting. Even with implements 241 that appear to have similar capabilities (e.g., sensors, actuators or the like) the range of operation, speed, responsiveness or the like of actuators may vary between implements 241. Similarly the types, sensitivity, sample rates or the like of the sensors on the implements 241 may vary, sometimes significantly. Accordingly, each permutation of the implement 241 potentially includes a variety of differing characteristic bundles that correspondingly provide variations in capabilities and functionality of the implement 241 relative to other agricultural planters.

As further shown in this example, the agricultural implement 241 includes an implement controller 242. The implement controller 242 is in communication with the implement sensors and actuators 246, 248 that facilitate operation of the implement 241. In some examples, the implement controller 242 includes autonomous operation capabilities including autonomous planting operability. In another example, the implement controller 242 is a proprietary controller that is developed and configured to work with the sensors and actuators 246, 248 of the present implement 241. Access to the sensors and actuators 246, 248 and use of the same is in some examples buried behind the implement controller 242 and frustrated by the proprietary controller controlling or precluding access to the sensors and actuators. As described herein, the autonomous agricultural assembly configurator 400 interfaces with one or more of the implement controller 242, sensors 246 and actuators 248 to access the capabilities of the implement 241.

Referring again to FIG. 2D, with this example agricultural implement 241 (planter) the implement attributes 244 include, but are not limited to, dimensions such as overall width, row unit width, axle positions, product applicator locations; weight; turning radius; number of row units; specified seed variety(s); number and identification of agricultural products for application (e.g., ammonia, fertilizer, or the like and application rates for the same); hydraulic requirements (e.g., for operation of coulters or disks). As discussed herein, the vehicle attributes 244 are received by the autonomous configuration profile generator 410 of the configurator 400 to permit construction of the autonomous configuration profile 412 of an autonomous operation based in part on those attributes 244, such as an agricultural planting operation.

The implement 241 further includes various sensors 246 that include one or more of, but are not limited to, row unit down pressure (load cell/lbs), row unit down pressure (psi); air pressure; vacuum pressure; agricultural product liquid pressure, flow rate; agricultural product granular rate (rpm); seed weight (load cell/lbs); fan rpm; frame position; row unit position; real time kinematics (RTK) sensor, GPS sensor; hydraulic supply pressure, hydraulic return pressure; or the like. The vehicle sensors 246, characteristics of the sensors, or the like are received by the autonomous configuration profile generator 410, and the generator 410 constructs the autonomous configuration profile 412 based on the vehicle sensors 246 available, for instance to facilitate autonomous operation and monitoring of the implement 241 (e.g., position, planting depth, agricultural product application rates, seed weight, or the like).

The implement 241 also includes the various actuators 248, such as one or more of, but not limited to, frame elevation; row unit lift; row unit rotation; vacuum fan (hydraulic); air pressure fan (hydraulic); flighted seed belt (hydraulic); pneumatic down pressure; hydraulic down pressure; hitch actuator; planter fold actuator (hydraulic); agricultural product liquid pump (hydraulic); agricultural product granular drive (hydraulic); or the like. The vehicle actuators 248, characteristics of the actuators, or the like are received by the autonomous configuration profile generator 410, and the generator 410 constructs the autonomous configuration profile 412 based on the vehicle actuators 248 available, for instance to facilitate autonomous operation of the implement 241 (e.g., planting rate, seed spacing, planting depth, agricultural product application, or the like).

FIG. 2E shows an example agricultural implement 251. In this example, the implement 251 is a seeder, including a plurality of row units, seed hoppers, coulters, disks or the like provided along a tool bar. The agricultural implement 251 has attributes 254, and includes implement sensors and actuators 256, 258, referred to as characteristics and, collectively, as characteristic bundles. The example agricultural implement 251 includes a permutation of characteristics such as dimensions, turning radius, or the like (attributes 254); and sensors (240, 242) that are specific to its make, model, year, buyer selected options or the like. For instance, optional sensors and actuators are included in some but not all models; a model uses seed belt or gravity drop for seeds; different capabilities are provided with regard to liquid agricultural product application, granular agricultural product application or the like; or high resolution sensors, like RTK sensors, are included for higher resolution indexing of planting. Even with implements 251 that appear to have similar capabilities (e.g., sensors, actuators or the like) the range of operation, speed, responsiveness or the like of actuators may vary between implements 251. Similarly the types, sensitivity, sample rates or the like of the sensors on the implements 251 may vary, sometimes significantly. Accordingly, each permutation of the implement 251 potentially includes a variety of differing characteristic bundles that correspondingly provide variations in capabilities and functionality of the implement 251 relative to other agricultural seeders.

As further shown in this example, the agricultural implement 251 includes an implement controller 252. The implement controller 252 is in communication with the implement sensors and actuators 256, 258 that facilitate operation of the implement 251. In some examples, the implement controller 252 includes autonomous operation capabilities including autonomous planting operability. In another example, the implement controller 252 is a proprietary controller that is developed and configured to work with the sensors and actuators 256, 258 of the present implement 251. Access to the sensors and actuators 256, 258 and use of the same is in some examples buried behind the implement controller 252 and frustrated by the proprietary controller controlling or precluding access to the sensors and actuators. As described herein, the autonomous agricultural assembly configurator 400 interfaces with one or more of the implement controller 252, sensors 256 and actuators 258 to access the capabilities of the implement 251.

Referring again to FIG. 2E, with this example agricultural implement 251 (seeder) the implement attributes 254 include, but are not limited to, dimensions such as overall width, row unit width, axle positions, product applicator locations; weight; turning radius; number of row units; specified seed variety(s); number and identification of agricultural products for application (e.g., ammonia, fertilizer, or the like and application rates for the same); hydraulic requirements (e.g., for operation of coulters or disks); or the like. As discussed herein, the vehicle attributes 254 are received by the autonomous configuration profile generator 410 of the configurator 400 to permit construction of the autonomous configuration profile 412 of an autonomous operation based in part on those attributes 254, such as an agricultural planting operation.

The implement 251 further includes various sensors 256 that include one or more of, but are not limited to, seed tube (optical), seed tube (ultrasound/acoustic); row unit down pressure (load cell/lbs), row unit down pressure (psi); air pressure; agricultural product liquid pressure, agricultural product liquid flow rate; agricultural product granular rate (rpm), agricultural product granular rate (acoustic); seed weight (load cell/lbs); fan rpm; hydraulic supply pressure, hydraulic return pressure, hydraulic case drain pressure; frame position; real time kinematics (RTK) sensor, GPS sensor; or the like. The vehicle sensors 256, characteristics of the sensors, or the like are received by the autonomous configuration profile generator 410, and the generator 410 constructs the autonomous configuration profile 412 based on the vehicle sensors 256 available, for instance to facilitate autonomous operation and monitoring of the implement 251 (e.g., position, planting depth, agricultural product application rates, seed weight, or the like).

The implement 251 also includes the various actuators 258, such as one or more of, but not limited to, frame elevation actuator; row unit lift actuator; air pressure fan (hydraulic); pneumatic down pressure actuator; hydraulic down pressure actuator; hitch actuator; seeder fold actuator (hydraulic); agricultural product liquid pump (hydraulic); agricultural product granular drive (hydraulic); or the like. The vehicle actuators 258, characteristics of the actuators, or the like are received by the autonomous configuration profile generator 410, and the generator 410 constructs the autonomous configuration profile 412 based on the vehicle actuators 258 available, for instance to facilitate autonomous operation of the implement 251 (e.g., planting rate, seed spacing, planting depth, agricultural product application, or the like).

FIG. 2F shows an example agricultural implement 261. In this example, the implement 261 is a tiller or cultivator, including a plurality of shafts or rotors having blades or tines; blades, shovels; disks, disk arms; sealing disks; agricultural product applicator; or the like provided along a tool bar. The agricultural implement 261 has attributes 264 and includes implement sensors and actuators 266, 268, referred to as characteristics and, collectively, as characteristic bundles. The example agricultural implement 261 includes a permutation of characteristics such as dimensions, turning radius, or the like (attributes 264); and sensors (240, 242) that are specific to its make, model, year, buyer selected options or the like. For instance, optional sensors and actuators are included in some but not all models; a model uses disks, tines, blades or shovels; different capabilities are provided with regard to liquid agricultural product application, granular agricultural product application or the like; or high resolution sensors, like RTK sensors, are included for higher resolution indexing of cultivation (e.g., to avoid planted crops). Even with implements 261 that appear to have similar capabilities (e.g., sensors, actuators or the like) the range of operation, speed, responsiveness or the like of actuators may vary between implements 261. Similarly, the types, sensitivity, sample rates or the like of the sensors on the implements 261 may vary, sometimes significantly. Accordingly, each permutation of the implement 261 potentially includes a variety of differing characteristic bundles that correspondingly provide variations in capabilities and functionality of the implement 261 relative to other agricultural tillers or cultivators.

As further shown in this example, the agricultural implement 261 includes an implement controller 262. The implement controller 262 is in communication with the implement sensors and actuators 266, 268 that facilitate operation of the implement 261. In some examples, the implement controller 262 includes autonomous operation capabilities including autonomous planting operability. In another example, the implement controller 262 is a proprietary controller that is developed and configured to work with the sensors and actuators 266, 268 of the present implement 261. Access to the sensors and actuators 266, 268 and use of the same is in some examples buried behind the implement controller 262 and frustrated by the proprietary controller controlling or precluding access to the sensors and actuators. As described herein, the autonomous agricultural assembly configurator 400 interfaces with one or more of the implement controller 262, sensors 266 and actuators 268 to access the capabilities of the implement 261.

Referring again to FIG. 2F, with this example agricultural implement 261 (tiller or cultivator) the implement attributes 264 include, but are not limited to, dimensions such as overall width, row unit width, axle positions, product applicator locations; weight; turning radius; number of row units; specified seed variety(s); number and identification of agricultural products for application (e.g., ammonia, fertilizer, or the like and application rates for the same); hydraulic requirements (e.g., for operation of blades, shovels, coulters or disks); or the like. As discussed herein, the vehicle attributes 264 are received by the autonomous configuration profile generator 410 of the configurator 400 to permit construction of the autonomous configuration profile 412 of an autonomous operation based in part on those attributes 264, such as an agricultural planting operation.

The implement 261 further includes various sensors 266 that include one or more of, but are not limited to, down pressure (load cell/lbs), down pressure (psi); agricultural product liquid pressure agricultural product liquid flow rate, agricultural product granular rate (rpm); frame position; tillage section position; blade, disk, shovel position; disk depth; chisel depth; hydraulic supply pressure, hydraulic return pressure, hydraulic case drain pressure; real time kinematics (RTK) sensor, GPS sensor; or the like. The vehicle sensors 266, characteristics of the sensors, or the like are received by the autonomous configuration profile generator 410, and the generator 410 constructs the autonomous configuration profile 412 based on the vehicle sensors 266 available, for instance to facilitate autonomous operation and monitoring of the implement 261 (e.g., position, tilling or cultivating depth, agricultural product application rates, or the like).

The implement 261 also includes the various actuators 268, such as one or more of, but not limited to, frame elevation actuator; tillage or cultivator section elevation actuator; tillage or cultivation section rotation actuator; hydraulic down pressure actuator; hitch actuator; frame fold actuator (hydraulic); agricultural product liquid pump (hydraulic); agricultural product control valve (electric, PWM or the like); agricultural product granular drive (hydraulic); or the like. The vehicle actuators 268, characteristics of the actuators, or the like are received by the autonomous configuration profile generator 410, and the generator 410 constructs the autonomous configuration profile 412 based on the vehicle actuators 268 available, for instance to facilitate autonomous operation of the implement 261 (e.g., tilling or cultivation depth; positioning of cultivation shovels, disks or blades relative to crops; agricultural product application; or the like).

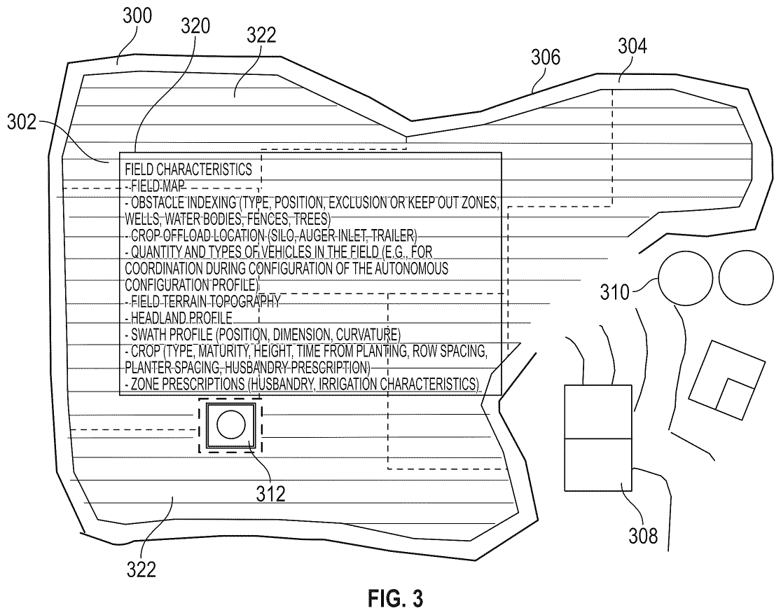

FIG. 3 is a plan view of one example of a field 300 including one or more features proximate or remote to the physical field, such as a crop offload location 310 and an agricultural vehicle and implement garage (e.g., shed, barn or the like). As shown in FIG. 3, the field 300 in this example includes a field interior 302, headland 304, field boundary 306, or the like. The field interior 302 includes soil, obstacles 312, and optionally planted crops (e.g., planted in rows or swaths). In one example, the field 300 is divided into one or more zones, shown with dashed lines. The one or more zones are optionally indexed, for instance in a field map, with respective zone prescriptions 322. A zone prescription 322 includes, but is not limited to, one or more of a crop variety (for planting or previously planted); specified husbandry characteristics, such as agricultural products, application rates; soil characteristics, elevations, topography; irrigation prescriptions; or the like.

The headland 304 of the field 300, in another example, includes the dimensions, shape, swaths (or rows) included in the headland or the like. Optionally, the headland 304 specifies a border of the field interior 302. As further shown in FIG. 3, the field 300 optionally includes the field boundary 306. The field boundary 306 is, in one example, an obstacle (e.g., border line) including, but not limited to a fence line. Various obstacles 312 are also illustrated with the field 300. The obstacles 312 includes an exclusion zone (dashed box) indicating a keep out zone for vehicles and implements operating in the field 300. Obstacles 312 include, but are not limited to, wind turbines, fences, water bodies, ditches, trees, rocks, steep grades, operator marked or designated zones, or the like. These features, such as the field interior 302, headland 304, field boundary 306, obstacles 312, or the like are in various examples indexed to a field map and permit guidance and operation of agricultural vehicles and implements in and around the field 300 including autonomous operation as discussed herein. Additionally, these features 302, 304, 306, 312, or the like are included as characteristics (e.g., collectively as a characteristic bundle) for the field 300. The autonomous agricultural assembly configurator 400 (and optional controller) receive the field characteristic bundle as an input and the autonomous configuration profile generator 410 constructs an autonomous operation profile for implementation by one or both of an agricultural vehicle or implement having their own characteristic bundles input to the configurator 400.

An agricultural vehicle and implement garage 308 is an example of an additional feature of the field 300 are shown in FIG. 3. The garage 308 (shed or the like) includes various agricultural vehicles, implements, locations, parking slots, or the like for storing and deploying of the agricultural vehicles and implements. As described herein the agricultural vehicles and implements are selectively interconnected as agricultural assemblies and are configured for an autonomous operation by way of an autonomous configuration profile with the autonomous agricultural assembly configurator 400. The garage 308 is optionally also included with the characteristic bundle for the field 300 and accordingly provides a virtual garage 308 that permits selection of one or more of a vehicle and implement when constructing an autonomous agricultural operation and the associated autonomous configuration profile for the operation. In another example, the location of the garage 308, parking slots for the vehicles and implements, GPS or RTK locations for vehicle and implements, are included as characteristics with the field 300 to permit autonomous driving, interconnection (of vehicle and implement), and driving to and from the field 300 (e.g., to and from the garage 308, along roads, or the like).

Another feature of the field 300 includes a crop offload location 310. The crop offload locations includes, but is not limited to, a silo, auger inlet, trailer, grain cart, or the like. In one example, the crop offload location 310 has an indexed location (e.g., relative to the field 300); offload mechanism type such as an auger inlet, grain cart dimensions, or the like as characteristics included in the field 300 characteristic bundle.

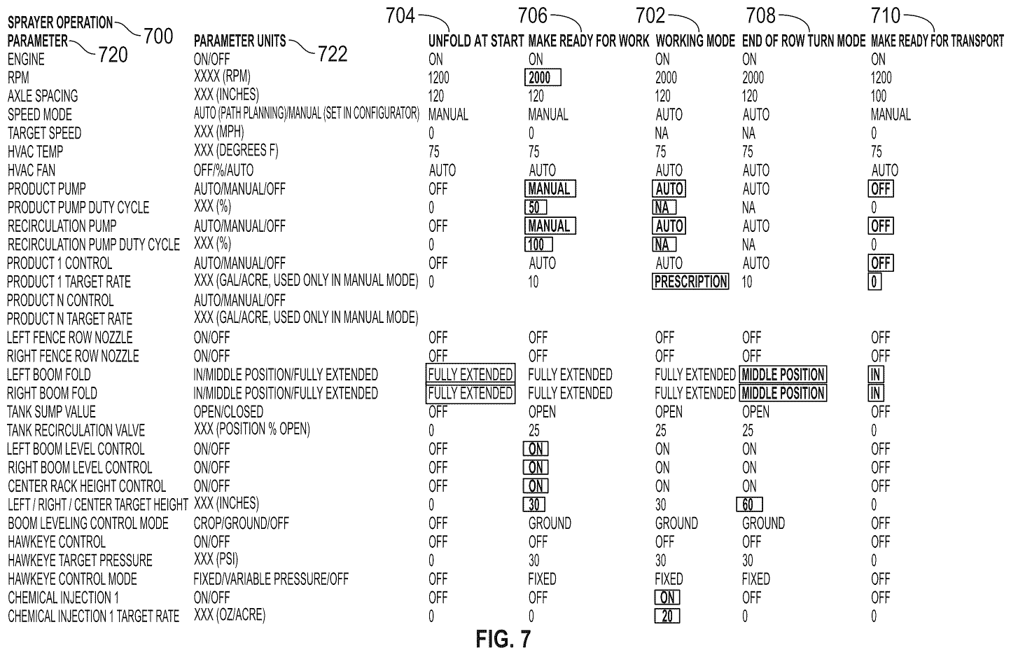

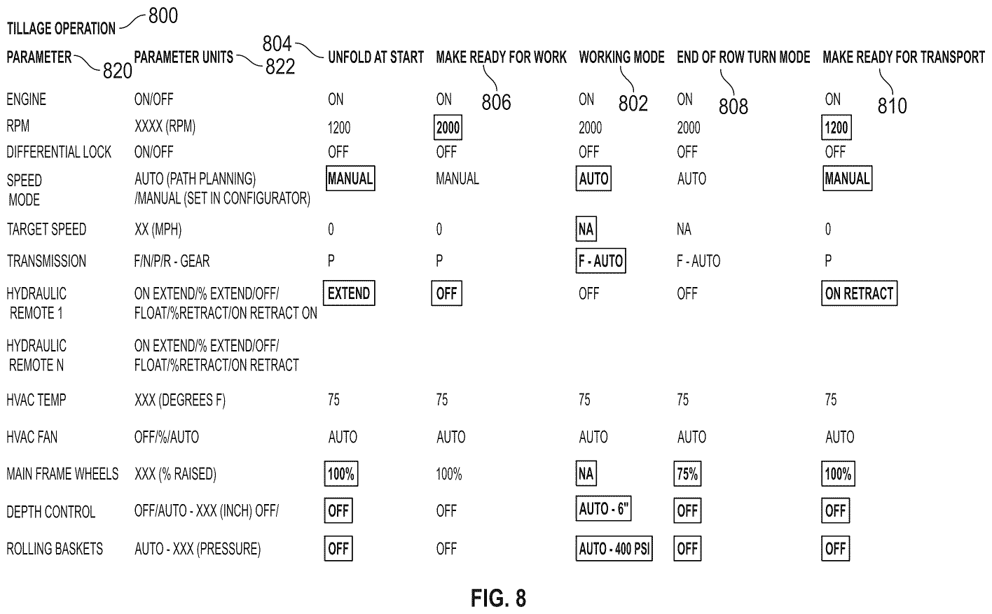

FIG. 3 includes example field characteristics 320. The example field characteristics 320 are in one example received by the autonomous agricultural assembly configurator 400 as an input for constructing an autonomous configuration profile (412, see FIG. 4). As shown in FIG. 3, the field characteristics 320 include, but are not limited to, a field map including the field interior 302 (row spacing, curvature of rows, guidance lines or the like), headland 304, boundary 306; obstacle 312 indexing (e.g., type, position, exclusion or keep out zones, wells, water bodies, fences, trees); crop offload location 310 (silo, auger inlet, trailer, cart); quantity and types of vehicles in the field (e.g., for coordination during configuration and implementation of the autonomous configuration profile); field terrain topography; headland 304 (e.g., dimensions, shape, swaths, guidance lines, or the like); swath profile (dimensions, curvature); crop (type, maturity, height, time from planting, row spacing, planting spacing, prescriptions); zone prescriptions 322 (husbandry, irrigation characteristics, or the like). The field characteristics 320 are received by the autonomous configuration profile generator 410 as inputs for constructing the autonomous configuration profile 412. Example autonomous configuration profiles are provided herein, and shown for instance in FIGS. 7 and 8. The field characteristics 320 (e.g., a field characteristic bundle) are provided by way of the field characteristic input 422 and, along with one or more vehicle or implement characteristic bundles (including composite bundles of characteristics), permit construction of the autonomous configuration profile 412. The profile 412 is provided to the vehicle and implement and the agricultural operation associated is autonomously implemented according to the specifications of the profile 412.

FIG. 4 shows one example of the autonomous agricultural assembly configurator 400, sometimes referred to herein as an autonomous implement controller (AIC). In this example, the configurator 400 includes both the configurator (configuration profile generator) and an optional autonomous profile controller 414. These components are in some examples provided separately, for instance with the configuration profile 412 provided to an existing controller of one or more of the vehicle or implement (445, 456 in FIG. 4) for implementation of the autonomous operation according to the autonomous configuration profile 412.

As shown in FIG. 4, the configurator 400 is a separate component (see dashed lines) relative to the agricultural vehicle 402 and the agricultural implement 404. The configurator 400 interfaces with one or more of the vehicle 402 or implement 404 through one or more of wired or wireless connections, such as a bus, CAN bus or the like. Instead of being a component of an existing autonomy template developed with the vehicle or implement, the configurator 400 and optional controller assemble the autonomous operation according to the received or input capabilities of one or more of the implement 404, vehicle 402, or field.

The configurator 400 includes one or more inputs, such as, a field characteristic input 422, vehicle characteristic input 420, implement characteristic input 424, or the like. Optionally, the one or more inputs include a single input configured to receive a composite bundle of component characteristic bundles. The configurator 400 discriminates and organizes the characteristics (e.g., field, vehicle or implement) of the component bundle to build the autonomous configuration profile based on the respective capabilities of the vehicle, implement, or field.

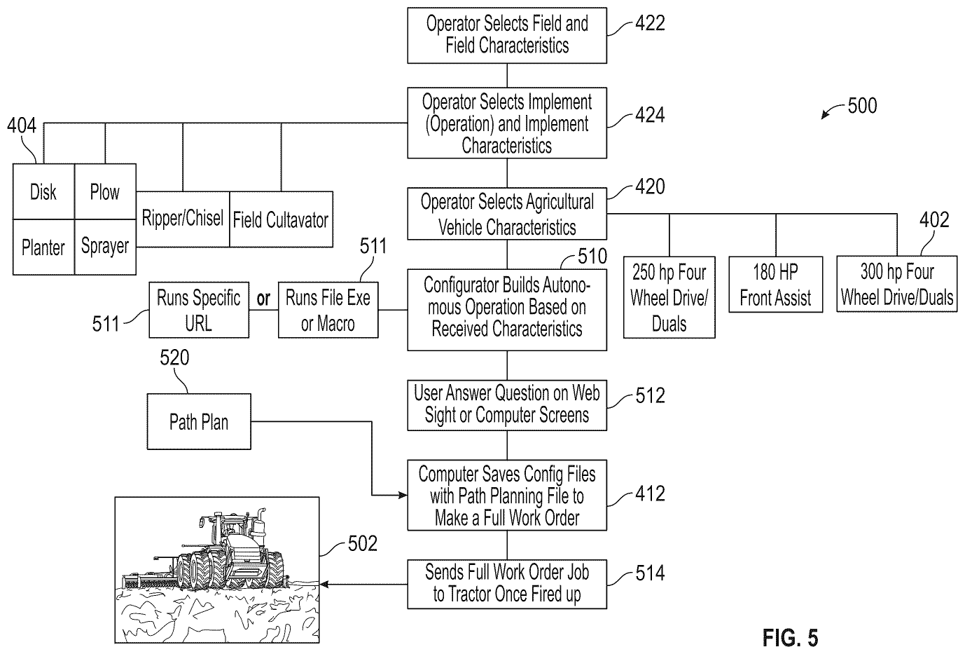

As described herein the inputs 420-424 receive and provide characteristic bundles to the autonomous configuration profile generator 410, and the generator 410 in turn constructs an autonomous configuration profile 412 based on the inputs, operator specifications, operator refinements, or the like for an agricultural operation, or the like. The autonomous configuration profile includes an agricultural operation and a plurality of operation parameters associated with the agricultural operation. In some examples, the operation parameters based on the input characteristic bundles of one or of the vehicle, field or implement 420, 422, 424. As one representative example, for a spraying operation the field characteristic input 422 provides the type of crop planted and husbandry prescriptions (e.g., designation of agricultural products for application, application rates, or the like). An example of profile construction is shown in FIG. 5.

Referring again to FIG. 4, the configurator 400 in one example includes a characteristic investigator 428. The characteristic investigator 428 communicates with electronic control units (ECUs) of the vehicle 402, implement 404 or the like (e.g., controllers 446, 456) and searches for and identifies available sensors, actuators, capabilities, tools or the like from the ECUs. In other examples, the investigator 428 searches for and identifies sensors, actuators, capabilities, tools or the like by way of connections through a BUS, wireless interface or similar. For instance, the investigator 428 actively interconnects with actuators, sensors or the like and identifies the same for use by the configurator 400.

In another example, the configurator 400 includes or has access to a characteristic memory 426 that retains characteristics (and collectively characteristic bundles) for one or more fields, vehicles, implements or the like. Optionally, the retained characteristics are maintained in a local server, field computer, remote server, internet database, or the like. In another option, the retained characteristics are accessed by way of scanning a bar code (e.g., appended to one or more vehicles 402 or implements 404), inputting a vehicle or implement identification tag, inputting a field identification tag, or the like. The respective characteristic bundles are associated with the tags, bar codes, or similar and provided to the generator 410 of the configurator 400 to permit generation (construction, assembly, synthesizing, or the like) of the autonomous configuration profile 412.

The autonomous configuration profile generator 410 in FIG. 4 receives the characteristic inputs including one or more of the inputs 420, 422, 424 and generates an autonomous configuration profile 412 include specification of an agricultural operation 430 and specification of operation parameters 432 for controlling conduct of the agricultural operation. For instance, the generator 410 identifies an operation type (or types), such as agricultural spraying, based on the implement characteristics (e.g., attributes 450, sensors 452, and actuators 454). The identified operation type is the specified agricultural operation 430.

The implement characteristic input 424 provides implement sensors 452, implement actuators 454, implement attributes 450, or the like associated with a designated sprayer implement (an example of implement 404). The generator 410 builds out the autonomous spraying operation including selecting sensors 452, actuators 454, or the like as operation parameters for the operation and populates the operation parameters with values, for instance one or more of sensor thresholds or machine learning type identification databases associated with input sensors 452; one or more actuator thresholds or settings for controlling the performance of sprayer actuators 454 (e.g., pump flow rates, control valve settings, agricultural product constituency or concentration). With the input 422 of field characteristics, such as planted crop type, row spacing, crop husbandry prescriptions, or the like one or more values are populated for the implement sensors 452 and implement actuators 454 that provide settings for the sprayer implement 404 (e.g., sensors 452, actuators 454, tool selection for use during the operation, or the like). Additionally, depending on the operation type, operation parameters, or the like the generator 410 may conduct initial queries or request selections by the operator for one or more parameter values of the operation parameters 432 including, but not limited to, agricultural product(s) for application; operation specifications for implements having multiple operation capabilities (type of harvesting, tillage, planting or the like); specification of parameter values, such as settings or thresholds; or the like.

In a similar manner, the vehicle characteristic input 422 provides sensors 442, actuators 444, vehicle attributes 440, or the like to permit the generator 410 to select sensors and actuators for the vehicle 402 as operation parameters 432 and further specify parameter values, such as thresholds or settings (e.g., permitted deviation from a guidance line, sprayer ground speed or speed range, threshold gravities (g's) for sprayer speed modulation during a turn, or the like). In one example, the operator is queried to input parameter values for one or more of the operation parameters 432 by the generator 410. Optionally, the implement characteristics 450, such as the implement turning radius, weight, or the like received by the generator 410 refine parameter values such as vehicle turning radius (limited by the implement turning radius), vehicle speed limit or range, or the like.

The autonomous configuration profile 412 is constructed with the autonomous configuration profile generator 410 includes the agricultural operation 430, operation parameters 432 and parameter values. The profile 412 is, in one example, a set of autonomous operation configurations, instructions, settings, thresholds or the like that are generated from the input of one or more of the field, implement or vehicle characteristics at inputs 420-424 and operator settings (e.g., boom height, application rate, or the like). The generation of the autonomous configuration profile 412 is in one example conducted at a farm, on site at a field, or after selection (by an operator) of one or more of a field, implement, or vehicle for conducting an operation in contrast to generation of an autonomous operation template written during development of one or more of the vehicle or implement.

Based on the submitted inputs 420-424 the generator 410 builds the configuration profile 412 with specified sensors, actuators, tools; settings or thresholds for the same; or the like that cooperatively use the input capabilities of the implement 404 and vehicle 402 to permit conduct of the autonomous operation (e.g., corresponding to the operation of the implement). The profile 412 is built based on the capabilities of one or more of the field, implement or vehicle and is done without preexisting operation templates that are specific to vehicles, implements, existing controllers or the like. Instead, the autonomous configuration profile 412 is an assembly of the autonomous operation, operation parameters, and parameter values for conduct of the operation. In various examples, the autonomous configuration profile 412 includes, but is not limited to, sensors and actuators for steering, ground speed, engine speed, transmission, power; sensors, actuators and tools for conducting the agricultural operation based on the input capabilities. The autonomous configuration profile 412 includes one or more thresholds or settings for the operation including as examples, but not limited to, a speed range, minimum turn radius; operation thresholds or settings (e.g., flow rate, sprayed product composition or concentration, boom height; header height, header speed; cultivator depth, knife spacing, coulter down force, hitch height, agricultural product flow rate, granular rate; planting depth, planting spacing, row spacing; or the like).

In one example, the autonomous configuration profile 412 is distributed to one or both of the vehicle 402 or implement 404. For instance, the profile 412 is provided to either or both of a vehicle controller 446 for the agricultural vehicle 402 or an implement controller 456 of the agricultural implement 404. The associated controllers 446, 456 implement the autonomous agricultural operation according to the profile 412.

In another example, the autonomous agricultural assembly configurator 400 includes an autonomous profile controller 414 that implements the configuration profile 412. The autonomous profile controller 414 interfaces with the sensors and actuators of one or both of the vehicle 402 or implement 404 (e.g., optionally through the respective onboard controllers 446, 456) and implements the autonomous operation. For example, the controller 414 conducts engine, speed, transmission and steering control through cooperative interfacing with sensors (e.g., vision, GPS, radar) and drives the assembly of the vehicle 402 and implement 404 based on sensor values, path plan, end of row turning profiles and thresholds for conduct of the operation. Further, the controller 414 conducts control of the implement 404 and cooperating control of the vehicle 402 of the agricultural assembly including monitoring with sensors (e.g., one or both of the vehicle or implement) and control of implement functions such as boom height, spray flow rate, planting depth, plant spacing, harvester component speeds, power or the like according to sensed conditions and thresholds or settings for the sensors 442, 452 or actuators 444, 454 provided by the autonomous configuration profile 412.

FIG. 5 is a block diagram illustrating the generation 500 of an example autonomous configuration profile 412. The generation 500 is initiated with inputting of one or more characteristic bundles and proceeds (in this example) in a downward manner and concludes with sending of the profile 412 to an agricultural assembly of a vehicle 402 and an implement 404 or submission to the autonomous profile controller 414 (see FIG. 4).

At 422 (corresponding to the field characteristic input 422 in FIG. 4), an operator selects a field for conduct of an agricultural operation. The field includes a field characteristic bundle of characteristics as described herein, for example see FIG. 3 and the associated description. The configurator 400 optionally permits the inputting of field characteristics by the operator, for instance by way of touchscreen, keyboard, selection from a database, or the like. At 424, the operator selects an implement 404. In one example, the implement 404 is selected from a virtual garage or list of implements 404 shown to the left of 424 in FIG. 5. Optionally, the selection of the implement 404 also selects the associated agricultural operation (e.g., selection of a sprayer correspondingly selects a spraying operation) for the configurator 400. Each of the implements 404 includes respective characteristic bundles. Upon selecting one of the implements 404 the selected implement and its associated characteristic bundle is input to the configurator 510 (410 in FIG. 4). Optionally, the operator is provided an opportunity by the configurator 410 to revise or update one or more of the characteristics of the implement characteristic bundle, for instance based on operator know how, experience or the like.

At 420, the operator selects a vehicle 402. In one example, the vehicle 402 is selected from a virtual garage or list of vehicles shown to the right of 420 in FIG. 5. Each of the vehicles 402 includes respective characteristic bundles. Upon selecting one of the vehicles 402 the selected vehicle and its associated characteristic bundle is input to the configurator 510 (410 in FIG. 4). Optionally, the operator is provided an opportunity by the configurator 410 to revise or update one or more of the characteristics of the vehicle characteristic bundle, for instance based on operator know how, experience or the like.

As described herein (e.g., see FIGS. 2A-F) the characteristic bundles for the vehicles 402 and implements 404 include a variety of information such as, but not limited to, implement or vehicle weight, dimensions; power, hitch type, turning radius; sensors; actuators; if/then type control instructions for situational circumstances detected with sensors. Optionally, the characteristic bundles also include capabilities or restrictions of capabilities of vehicle or implement, such as turning radius; boom length, boom height range; pump pressure range, pump flow rate range; hydraulic pressure range; header height range; belt or auger speed range; or the like.

At 510, the configurator (410 in FIG. 4) builds the autonomous operation according to the input characteristic bundles associated with the one or more selected, field, implement or vehicle. The characteristic bundles provide a suite (e.g., list, compendium, collection, or compilation) of capabilities across the vehicle and implement to build the autonomous operation with the configurator 410. The configurator 410 builds out the autonomous operation based on the capabilities, for instance by listing operation parameters and providing associated parameter values (e.g., thresholds, settings, prescribed actions, proscribed actions, values corresponding to husbandry prescriptions, or the like) associated with those capabilities, such as sensors, actuators, tools or the like.

The configurator 410, in one example, includes one or algorithms, macros executable programs, accesses a cloud or server based algorithm or uniform resource locator (URL), or the like (e.g., collectively, algorithms 511) that generate the autonomous configuration profile from the input characteristic bundles. Examples of autonomous configuration profiles 700, 800 are shown in FIGS. 7 and 8, and described herein.

At 512, parameter values, such as thresholds, settings, prescribed actions, proscribed actions, or the like are input based on one or more of operator queries. For instance, a user interface is provided with the initial autonomous configuration profile 412 assembled by the generator 410 of the configurator 400. One or more parameter values for the initial configuration profile 412 are editable by way of operator interaction at 512. For instance, thresholds (also referred to as settings), such as operation type for an implement capable of different operations, application rates, duty cycles, tool heights, boom heights, driving speeds or the like are optionally selected or varied by the operator based on operator experience, an online database, catalog or the like.

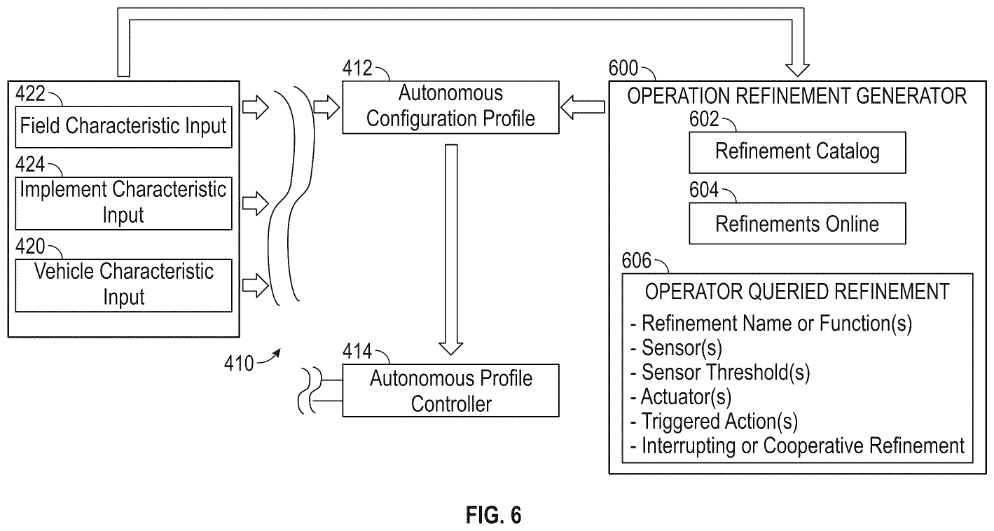

Optionally, at 512 the configurator 410 provides the operator with queries or input to generate operation refinements. As described herein (e.g., see FIG. 6), operation refinements provide the operator with an opportunity to further resolve the autonomous configuration profile to address situations the operator recognizes and further recognizes how to address based on experience and know how. Generating an operation refinement for an end of row turn for an agricultural sprayer is one example of a refinement. In practice, the operator, when driving the sprayer, at least partially raises sprayer booms and limits sprayer speed to decrease boom swing (referred to as whipping) of the sprayer booms and proximate to spraying the next rows of crops lowers the sprayer booms to a specified boom height for continued spraying. As discussed herein, at 512 the operator inputs the operation refinement with the autonomous agricultural assembly configurator 400, and the refinement is incorporated into the autonomous configuration profile 412. The refinement includes, but is not limited to, specified sensors for monitoring and triggering initiation of the refinement, sensor thresholds (also referred to as settings), input actuators for conduct of the refinement, actuator thresholds (also referred to as settings or actions), and input having the refinement as an interruption to the agricultural operation or cooperative function used with agricultural operation when initiated. Optionally, the operator may select refinements from an online database, database of previously developed refinements, or the like.

After the operator queries, inputs and optional operation refinement generation at 512, the autonomous configuration profile 412 is completed and saved for implementation to the agricultural assembly 502 (e.g., one or more of the vehicle 402 or implement 404). Optionally, a path plan 520 is appended to, and optionally becomes a component of, the autonomous configuration profile. The path plan 520 is provided from one or more of a field map (e.g., onboard a field computer included with the vehicle 402), database, server or the like. Alternatively, the path plan 520 is generated as a portion of the configurator 410 operation. For instance, the path plan 520 is constructed based on one or more of a field map, the input field characteristic bundle, implement characteristic bundle, vehicle characteristic bundle, or the like.

At 514, the autonomous configuration profile 412 including the parameters, parameter values, and, optionally, one or more of operation refinements or the path plan are submitted to the agricultural assembly 502, such as one or both of the vehicle 402 or implement 404 (e.g., their respective controllers 446, 456). In another example, the autonomous configuration profile 412 is provided to the autonomous profile controller 414, and the controller 414 implements the profile 412 to conduct the autonomous agricultural operation. In this configuration, the autonomous profile controller 414 provides instructions to one or both of the vehicle or implement controllers 446, 456. For instance, the controllers 446, 456 interpret instructions from the autonomous profile controller 414, and relay the interpreted instructions to the sensors (e.g., processors associated with the sensors), actuators or the like. Alternatively, the autonomous profile controller 414 directly interfaces with the vehicle sensors and actuators 442, 444 and the implement sensors and actuators 452, 454, and implements the autonomous agricultural operation with those sensors and actuators.

FIG. 6 is a block diagram showing a portion of the autonomous profile configurator 400 of FIG. 4, and further including an operation refinement generator 600 in communication with the remainder of the configurator 400. As previously discussed, operation refinements improve or modify the autonomous configuration profile to address situations the operator recognizes and further recognizes how to address based on experience and know how.

As shown in FIG. 6, the operation refinement generator 600 receives (including accessing) one or more of the inputs 420-424 including, but not limited to, the field characteristic bundle, vehicle characteristic bundle, or implement characteristic bundle, or the like provided to the configurator 400 for generation of the autonomous configuration profile 412. Further, the operation refinement generator 600 accesses the autonomous configuration profile 412. The operator accordingly may edit, revise, supplement, or the like (e.g., refine) the autonomous configuration profile 412 with the operation refinement generator 600.

The operation refinement generator 600 includes one or more of an operator queried refinement function 606, a refinement catalog 602, or online refinement access. With the queried refinement function 606, an interface (e.g., a graphic user interface, screen and keyboard, or the like) are provided. FIG. 6 illustrates an example series of options available to the operator for crafting operation refinements. For instance, the queried refinement function permits the designation of a refinement name or function for cataloging and access of the refinement; selection of available sensors for generating the refinement; selection of sensor thresholds (e.g., settings, access to a machine learning algorithm such as for obstacle, crop, weed, or pest identification); selection of available actuators; selection of triggered actions (e.g., including generation of actions) with the selected actuators including, but not limited to, settings for the actuators; and optionally designation of the refinement as a cooperative refinement conducted as part of the agricultural operation implemented by the autonomous configuration profile 412 or designation as an interrupting refinement that temporarily interrupts the autonomous operation.

With regard to the available sensors for the queried refinement function 606, sensors are available for selection based on implement 404 and vehicle 402 selections (e.g., the specification of the vehicle and implement and reception or input of their associated characteristic bundles). For instance, if one or more of the vehicle 402 or implement 404 includes LiDAR, vision (camera, video camera, or the like), infrared, normalized difference vegetation index (NDVI) sensors those sensors are available for selection during generation of an operation refinement. In a similar manner, actuators are available for selection based on implement 404 and vehicle 402 selections. For instance, if the selected vehicle 402 or implement 404 includes one or a plurality of hydraulic boom actuators, crab steering capable motors, agricultural product pumps, modulating spray nozzles or the like those actuators are available for selection during generation of an operation refinement.

In other examples, the refinement generator 600 includes one or more of a refinement catalog 602 or access to online refinements 604. For example, with a refinement catalog 602 operation refinements are maintained in a database and are selected by an operator as needed. Optionally, the operator generates their own refinements (see the queried refinement function 606) and saves the refinement to the catalog 602 to permit selection of the refinement for future autonomous configuration profiles. In another example, operation refinements are available online for perusal and selection by an operator. In some examples, an online database is maintained by one or more operators, an OEM, or support team that permits storage and selection of generated refinements by operators. Optionally, operator generated refinements (see the queried refinement function 606) are uploaded to the online refinements 604 database for use with other configurators 400, for instance installed or in communication with vehicles, implements or the like of other operators.

Generated operation refinements are provided to the configurator 400. In one example, the operation refinements are included with the autonomous configuration profile 412 and thereby provide a refined or edited version of the profile 412 that provides enhanced functionality to the autonomous operation of the selected vehicle 402 or implement 404 beyond the initial autonomous operation implementation provided with the base profile. For instance, the operation refinements permit implementation of the operation in a manner approximating the preferences and experienced control of the operator because the refinements are based on the operator practices and know how. Examples of autonomous configuration profiles 700, 800 and associated example operation refinements are shown in FIGS. 7 and 8 as well as the associated description.

FIG. 7 shows an example autonomous configuration profile 700 for an agricultural assembly including an agricultural sprayer. The example agricultural sprayer is similar in at least some regards to the example agricultural vehicle 230 and implement 231 shown in FIG. 2C. As previously discussed the autonomous configuration profile 700 includes parameters, associated parameter values, and optional operation refinements for implementing an autonomous agricultural operation with one or more of a selected agricultural vehicle 402 or selected agricultural implement 404. The autonomous configuration profile 700 is generated by the autonomous agricultural assembly configurator 400 (FIG. 4), and is generated based on the capabilities of the selected vehicle, selected implement or both. The capabilities are input as characteristic bundles along with an optional field characteristic bundle. The configurator 400 generates the framework of the autonomous operation (e.g., the autonomous configuration profile) based on those characteristics. The autonomous configuration profile is provided to the agricultural assembly to autonomously conduct the specified agricultural operation.

In the example shown in FIG. 7, the characteristic bundle received for the selected agricultural sprayer includes collected characteristics for the implement portion of the sprayer (e.g., nozzles, booms, pumps, valves, sensors) and vehicle portion of the sprayer (e.g., steering; engine; transmission; throttle; HVAC). The configurator populates parameters 720 based on the collected characteristics. For instance, as shown for the populated parameters 720 in the example configuration profile 700 actuators, sensors or the like are directly or indirectly listed. Example listings of characteristics as parameters include, but are not limited to, axle spacing (dimension), product pump (one or more actuators), Hawkeye target pressure (one or more pressure sensors), as well as the other parameters shown in FIG. 7. In some examples, these parameters 720 correspond to sensors, actuators, and attributes of the sprayer collected and assigned to the autonomous configuration profile for use with an autonomous spraying operation. These characteristics serve as the inputs and outputs for the autonomous operation and its implementation by the configurator 400 and the optional controller 414. The parameters shown here are provided for the Working Mode 702, a base autonomous configuration profile for the autonomous spraying operation, and one or more operation refinements 704-710.

Parameter units 722 provide one or more selectable or input ready options for the associated parameters 720. The parameter units 722 provide one or more toggleable states for the parameters 720, such as ‘on’, ‘off’, or the like, numerical units such as gallons per minute, miles per hour, duty cycle (a percentage), percent open (or closed), inches or meters (for boom height or left/right/center target height), or the like. The parameter units 722, when populated with the parameters 720, provide selection options for the configurator 400 and operator to generate the autonomous configuration profile. For example, for the RPM parameter a numerical value of rpms is available for input or selection of an engine speed that determines throttle actuator and potentially transmission actuator operation. In another example, for the Hawkeye Control Mode for one or more pressure regulators the parameter values include fixed pressure, variable pressure, or ‘off’ conditions that permit selection by the configurator 400 or operator of agricultural product fixed pressure control, variable pressure control, or no pressure control while applying agricultural products. The parameters 720 and parameter values 722 are optionally available for setting, modification, or the like for each of the base autonomous configuration profile (the Working Mode 702) as well as the operation refinements 704-710.

Referring again to FIG. 7, an example base autonomous configuration profile is referred to as Working Mode 702. The base autonomous agricultural operation in this example includes parameters and selected parameter values for conduct of the autonomous agricultural operation (e.g., autonomous spraying and driving of the sprayer). For instance, specified speed (driving speed), application rate (gallons per acre), one or more of valve or nozzle duty cycles, boom height, engine rpm, wheel positioning (axle spacing), or the like are parameters with specified values for the Working Mode 702. For instance, example parameter values for the Working Mode 702 include, but are not limited to, 2000 rpms for engine speed (RPM), Product Pump toggled to ‘AUTO’ (automatic or feedback control) setting, Product 1 Control set to ‘AUTO’, Product 1 Target Rate set to ‘PRESCRIPTION’ to set the target flow rate based on a husbandry prescription (e.g., provided with one or more of the field or implement characteristic bundle), left and right boom fold actuators set to ‘fully extended’, left/right/center target (or boom) height set at 30 inches, Chemical Injection 1 set to ‘ON’, and the Chemical Injection Target Rate set to 20 ounces per acre. With these parameters 720, parameter values 722 and implementation of the profile 700 with a controller, such as one or more of the autonomous profile controller 414, vehicle controller 446, or implement controller 456 and a path plan appended to the configuration profile 700 the autonomous operation is implemented in a selected field with the selected vehicle and implement, in this case the example sprayer shown in FIG. 2C.

For instance, the collected sensors, actuators, and attributes from one or more of the field, implement and vehicle are cooperatively accessed and operated to conduct the agricultural operation autonomously. For instance, the vehicle and implement sensors 442, 452 monitor the operation of the agricultural assembly and surrounding field thereby permitting navigation and driving of the assembly through the field (e.g., along a path plan for the operation). The vehicle and implement actuators 444, 454 are operated to autonomously drive the agricultural assembly and autonomously conduct the agricultural operation. In some examples, sensors 442, 452 are cooperatively monitored across the vehicle and implement for assisting with either or both of the autonomous agricultural operation and the associated autonomous driving. For instance, vision sensors provided with the vehicle 402 are directed ahead of the vehicle 402, for instance to facilitate autonomous driving relative to crop rows. The vision sensors are, in one example, tasked with the autonomous agricultural assembly configurator 400 to conduct a higher resolution scans of the crops, provide the scans to the controller 414 or implement controller 456, and thereby permit spot application of agricultural products to identified crops, such as crops in poor health, pests proximate to identified crops, or the like. In a similar manner, implement sensors 452, monitor performance of the implement 404 and optionally monitor the area proximate to the implement 404. In one example, monitoring of sprayed agricultural products from spray booms identifies misalignment of spray nozzles with crop rows. The misalignment is provided to the autonomous profile controller 414 or vehicle controller 446 to permit refinement of autonomous driving to address the misalignment.

In another example with an implement 404 such as a cultivator, sensors 452 including strain gauges, load cells, or the like associated with chisels, shovels or coulters measure resistance to the implement operation and the measured resistance is supplied to the autonomous profile controller 414 or vehicle controller 446 to permit refinement of the driving operation, such as increase to engine power, to overcome resistance, such as a rock impinging the coulter. In yet another example, vision sensors are included as implement sensors 452 with the cultivator to monitor coulter position relative to proximate crop rows. In this example, the monitored position is provided to either of the autonomous profile controller 414 or the vehicle controller 446 to conduct refinements of autonomous driving to thereby refined the positions coulters as specified (e.g., away from crops).

FIG. 7 further includes example operation refinements 704-710. The operation refinements 704-710 are generated by an operator, pulled from a catalog (e.g., memory) or an online database of operation refinements, for instance with the operation refinement generator 600 shown in FIG. 6. The refinements presented optionally begin with similar or identical values to the base configuration profile, such as the Working Mode 702. Parameter values 722 of the parameters 720 are then input based on operator selections, incorporation of stored operation refinements, or the like.

A first operation refinement includes an Unfold At Start refinement 704. As shown in FIG. 7, the operation refinement 704 deploys the left and right booms of the sprayer. The parameter values changed with this operation refinement 704 are shown in boxed text, such as Left and Right booms deployed to “fully extended”. In another example, the operation refinement 704 includes one or more settings or thresholds that trigger conduct of the refinement. For example, the operation refinement 704 is triggered through one or more of arrival at the selected field and aligning with a first row (e.g., when an onboard GPS/RTK sensor corresponds to field and start locations). In another example, the operation refinement 704 is conducted based on a combination of settings, such as the sprayer engine is ‘ON’ and the sprayer is located at the field (GPS/RTK sensor corresponds to the field location).

Another operation refinement 706 for the autonomous configuration profile 700 includes Make Ready for Work in FIG. 7. In this operation refinement the parameter values associated with readying the sprayer for conducting a spraying operation are implemented. For instance, the plumbing, nozzles, and the like of the sprayer are primed through operation of pumps, control valves, pressure regulators (example implement actuators) in preparation for the spraying operation (e.g., the Working Mode 702).

In one example, a threshold refinement parameter (or trigger) for the operation refinement 706 includes detected aligning of the sprayer, sprayer boom or the like with a first row (e.g., a GPS/RTK sensor corresponds to field and start locations). In another example, the detected alignments prompts the initiation of the operation refinement 706 including an increase of engine speed to 2000 rpm (throttle and transmission are the example actuators) to provide power for pump operation. Additionally, the Agricultural Product Pump is set to ‘manual’ with an initial duty cycle of 50 percent, and the Recirculation Pump for this sprayer is set to ‘manual’ with an initial duty cycle of 100 percent for priming of the plumbing, valves and nozzles. The left and right boom controls and center rack controls (e.g., boom actuators) are powered with an initial boom height of 30 inches from target (e.g., ground, crop canopy or the like).

FIG. 7 includes another operation refinement 708, an End of Row Turn refinement that transitions sprayer booms to folded and partially raised configurations to decrease boom moment, whipping and collisions with proximate obstacles, such as fences. The trigger (or threshold refinement parameter) for the operation refinement 708 includes a GPS or vision sensor observation indicating completion of spraying along a swath of crop rows. The completion of the crop row initiates the end of row turn provided with the operation refinement 708. The refinement 708 is an example refinement that interrupts the conduct of the operation with the base autonomous configuration profile (e.g., Working Mode 702). The actuator refinement parameter values folding of the left and right booms at joints to a ‘middle position’ and setting of boom height control to 60 inches instead of the autonomous configuration profile setting (e.g., 30 inches) for spraying. These actuator refinements are conducted with one or more of sprayer boom actuators and optionally sprayer suspension actuators. The actuators for the vehicle portion of the sprayer are operated to implement a specified end of row turn (e.g., lightbulb, arc shaped turns, or the like). Completion of the operation refinement 708 and associated return to the Working Mode 702 is initiated based on GPS or vision sensor indicated arrival at a next swath of crop rows, indicating completion of the end of row turn. In this example, another actuator refinement parameter is initiated that returns to implementation of the autonomous configuration profile operation (e.g., Working Mode 702). Accordingly, actuators that were controlled according to the preceding End of Row Turn refinement (708) are then operated to the specifications provided with the Working Mode 702 refinement.

Make Ready for Transport 710 is another operation refinement for the autonomous configuration profile 700 for the selected sprayer. The Make Ready for Transport refinement transitions the sprayer to a road ready configuration after completion of a sprayer operation. For instance, the sprayer booms are folded for transport (e.g., on roads) while driving speed is increased for driving along smooth road surfaces. In one example, the threshold refinement parameter (or trigger) for the refinement 710 includes an indication that a path plan or autonomous spraying operation is completed, for instance with a field computer, GPS or RTK sensor of the sprayer and controller 414 (or implement controller 456) monitoring of operation status (e.g., 100 percent complete). Upon determination the agricultural operation is completed the Make Ready for Transport 710 refinement is initiated. For example, the actuators associated with the sprayer plumbing are operated to ‘off’ parameter values to shut down pumps, close valves, close nozzles, or the like. Additionally, Left and Right Boom Fold actuators are transitioned to the ‘in’ position to fold the sprayer booms with associated boom actuators, boom suspension actuators or the like. In another example, autonomous driving actuators (steering, transmission, engine, brakes) of the vehicle portion of the sprayer are operated to drive the sprayer to a shed or clean out location based on GPS, vision sensors or the like. The Make Ready for Transport 710 operation refinement is another example of an interrupting refinement that overrides further conduct of the Working Mode 702 base autonomous configuration profile.

FIG. 8 shows an example autonomous configuration profile 800 for an agricultural assembly including an agricultural vehicle (e.g., a tractor or prime mover) and an implement, such as a tiller or cultivator. The example agricultural tiller is similar in at least some regards to the example agricultural vehicle and implement 251 shown in FIG. 2F. As previously discussed, the autonomous configuration profile 800 includes parameters, associated parameter values, and optional operation refinements for implementing an autonomous agricultural operation with one or more of a selected agricultural vehicle 402 (e.g., a tractor or prime mover) or selected agricultural implement 404, in this example a tiller implement 251. The autonomous configuration profile 800 is generated by the autonomous agricultural assembly configurator 400 (FIG. 4), and is generated based on the capabilities of the selected vehicle, selected implement or both. The capabilities are input as characteristic bundles along with an optional field characteristic bundle. The configurator 400 generates the framework of the autonomous operation (e.g., the autonomous configuration profile) based on those characteristics. The autonomous configuration profile is provided to the agricultural assembly to autonomously conduct the specified agricultural operation.

In the example shown in FIG. 8, the characteristic bundle received for the selected agricultural tiller includes collected characteristics for the implement (e.g., attributes such as dimensions, turning radius, hydraulic requirements; and sensors and actuators such as seed tube sensors, row unit down pressure sensors, agricultural product flow meter, hydraulic supply pressure sensors; and actuators such as row unit lift actuators, agricultural product liquid pump, granular drive) and vehicle portion of the assembly (e.g., attributes such as dimensions and turning radius; actuators such as steering, engine, transmission, throttle, HVAC, power take off capability; and sensors such as speedometer, vision sensors for steering guidance, or the like). The configurator 400 populates parameters 820 based on the collected characteristics. For instance, as shown for the populated parameters 820 in the example configuration profile 800 actuators, sensors or the like are directly or indirectly listed. Example listings of characteristics as parameters include, but are not limited to, target speed (brake, throttle and engine actuators), speed mode, hydraulic remotes (actuators for deployment of tiller wings), depth control (vision sensors and hydraulic actuators), rolling baskets (pressure sensors), as well as the other parameters shown in FIG. 8. In some examples, these parameters 820 correspond to sensors, actuators, and attributes of the tiller collected and assigned to the autonomous configuration profile 800 for use with an autonomous tilling operation. These characteristics serve as the inputs and outputs for the autonomous operation and its implementation by the configurator 400 and the optional controller 414. The parameters shown here are provided for the Working Mode 802, a base autonomous configuration profile for the autonomous tilling operation, and one or more operation refinements 804-810.

Parameter units 822 provide one or more selectable or input ready options for the associated parameters 820. The parameter units 822 provide one or more toggleable states for the parameters 820, such as ‘on’, ‘off’, or the like, numerical units such as pressure, miles per hour, inches or meters (for depth control), or the like. The parameter units 822, when populated with the parameters 820, provide selection options for the configurator 400 and operator to generate the autonomous configuration profile. For example, for an RPM parameter a numerical value of rpms is available for input or selection of an engine speed of the selected tractor that determines throttle actuator and potentially transmission actuator operation. In another example, for the Depth Control parameter of chisels, shovels, disks or the like and associated pressure regulators include parameter values such as off, auto (to a specified pressure value or range), and off. The parameters 820 and parameter values 822 are optionally available for setting, modification, or the like for each of the base autonomous configuration profile (the Working Mode 802) as well as the operation refinements 804-810.

Referring again to FIG. 8, an example base autonomous configuration profile is referred to as Working Mode 802. The base autonomous agricultural operation in this example includes parameters and selected parameter values for conduct of the autonomous agricultural operation (e.g., autonomous tilling and driving of the prime mover, such as a tractor). For instance, target speed (driving speed), speed mode (auto or manual), main frame wheel deployment (a percent), depth control (depth dimension), and rolling baskets (automatic control and pressure value), or the like are parameters with specified values for the Working Mode 802. For instance, example parameter values for the Working Mode 802 include, but are not limited to, 2000 rpms for engine speed (RPM), Transmission toggled to ‘F-AUTO’ (automatic transmission in the forward direction), depth control for chisels, disks or blades set to ‘AUTO’ (automatic control) and a 6 inch target depth as a threshold, Rolling Baskets set to ‘AUTO’ (automatic control) and a pressure value to set pressure control to a specified 400 psi target value. With these parameters 820, parameter values 822 and implementation of the profile 800 with a controller, such as one or more of the autonomous profile controller 414, vehicle controller 446, or implement controller 456 and a path plan appended to the configuration profile 800 the autonomous operation is implemented in a selected field with the selected vehicle and selected implement, in this case the example tiller shown in FIG. 2F.

For instance, the collected sensors, actuators, and attributes from one or more of the field, implement and vehicle are cooperatively accessed and operated to conduct the agricultural operation autonomously. For instance, the vehicle and implement sensors 442, 452 monitor the operation of the agricultural assembly and surrounding field thereby permitting navigation and driving of the assembly through the field (e.g., along a path plan for the operation). The vehicle and implement actuators 444, 454 are operated to autonomously drive the agricultural assembly and autonomously conduct the agricultural operation. In some examples, sensors 442, 452 are cooperatively monitored across the vehicle and implement for assisting with either or both of the autonomous agricultural operation and the associated autonomous driving. For instance, vision sensors provided with the vehicle 402 are directed ahead of the vehicle 402, for instance to facilitate autonomous driving relative to crop rows. The vision sensors are, in one example, tasked with the autonomous agricultural assembly configurator 400 to conduct a higher resolution scans of the field, soil or the like, provide the scans to the controller 414 or implement controller 456, and thereby permit identification of obstacles, rocks or the like to avoid or prepare (e.g., higher pressure and associated chisel force) for potential collisions between tiller tools (chisels) and the identified obstacles. In a similar manner, implement sensors 452, monitor performance of the implement 404 and optionally monitor the area proximate to the implement 404. In one example, monitoring of the tilling operation from vision sensors provided on the implement detects misalignment relative to a swath, or in the case of a cultivator relative to crop rows. The misalignment is provided to the autonomous profile controller 414 or vehicle controller 446 to permit refinement of autonomous driving to address the misalignment.

In another example with an implement 404, sensors 452 such as strain gauges, load cells, or the like associated with chisels, shovels or coulters measure resistance to the implement operation and the measured resistance is supplied to the autonomous profile controller 414 or vehicle controller 446 to permit refinement of the driving operation, such as increase to engine power, to overcome resistance or drive around a rock impinging the coulter. In yet another example, vision sensors are included as implement sensors 452 with a cultivator to monitor chisel or shovel position relative to proximate crop rows. In this example, the monitored position is provided to either of the autonomous profile controller 414 or the vehicle controller 446 to conduct refinements of autonomous driving to thereby refined the positions coulters as specified (e.g., away from crops).

FIG. 8 further includes example operation refinements 804-810. The operation refinements 804-810 are generated by an operator, pulled from a catalog (e.g., memory) or an online database of operation refinements, for instance with the operation refinement generator 600 shown in FIG. 6. The refinements presented optionally begin with similar or identical values to the base configuration profile, such as the Working Mode 802. Parameter values 822 of the parameters 820 are then input based on operator selections, incorporation of stored operation refinements, or the like to accomplish the operation refinement either as an interrupting refinement that at least temporarily suspends the base profile 802 or to cooperatively conduct the operation refinement while the base profile 802 is implemented.

A first operation refinement includes an Unfold At Start refinement 804. As shown in FIG. 8, and similar to the refinement 702 shown in FIG. 7, the operation refinement 804 deploys the wings of the tiller. The parameter values changed with this operation refinement 804 are shown in boxed text, such as “ON EXTEND”, “% EXTEND”, “% RETRACT”, and so on. In another example, the operation refinement 804 includes one or more settings or thresholds that trigger conduct of the refinement. For example, the operation refinement 804 is triggered through one or more of arrival at the selected field and aligning with a first row or start location (e.g., when an onboard GPS/RTK sensor corresponds to field and start locations). In another example, the operation refinement 804 is conducted based on a combination of settings, such as the engine is ‘ON’ and the tiller is located at the field (GPS/RTK sensor corresponds to the field location).

Another operation refinement 806 for the autonomous configuration profile 800 includes Make Ready for Work in FIG. 8. In this operation refinement the parameter values associated with readying the tiller for conducting a tillage operation are implemented. For instance, the tractor engine speed (RPMs) are increased, hydraulic system for deployment of the wings is arrested (‘OFF’) in preparation for supply to the tools, and where agricultural products are available for delivery to tilled soil associated pumps, valves or the like are primed in preparation for the tillage operation (e.g., the Working Mode 702).

In one example, a threshold refinement parameter (or trigger) for the operation refinement 806 includes detected aligning of the tiller, tiller tools (e.g., chisels, blades, or the like) with a first row, first swath or start location (e.g., a GPS/RTK sensor corresponds to field and start locations). In another example, the detected alignment prompts the initiation of the operation refinement 806 including an increase of engine speed to 2000 rpm (throttle and transmission are the example actuators) to provide power for pulling the tiller implement.

FIG. 8 includes another operation refinement 808, an End of Row Turn refinement that transitions main frame wheels to a partially deployed configuration to support the tiller implement and facilitate turning. The trigger (or threshold refinement parameter) for the operation refinement 808 includes a GPS or vision sensor observation indicating completion of tillage along a swath of the field, arrival at the end of a guidance line (e.g., by comparison of the GPS position with a path plan). The completion of the swath initiates the end of row turn provided with the operation refinement 808. The refinement 808 is an example refinement that interrupts the conduct of the operation with the base autonomous configuration profile (e.g., Working Mode 802). The actuator refinement parameter values include setting of the main frame wheels to a 75 percent deployment and shutting off hydraulic supply for depth control and the rolling baskets. These actuator refinements are conducted with one or more of tiller actuators. The actuators for the vehicle portion of the assembly are operated to implement a specified end of row turn (e.g., lightbulb, arc shaped turns, or the like). Completion of the operation refinement 808 and associated return to the Working Mode 802 is initiated based on GPS or vision sensor indicated arrival at a next swath, indicating completion of the end of row turn. In this example, another actuator refinement parameter is initiated that returns to implementation of the autonomous configuration profile operation (e.g., Working Mode 802). Accordingly, actuators that were controlled according to the preceding End of Row Turn refinement 808 are then operated to the specifications provided with the Working Mode 802 refinement.

Make Ready for Transport 810 is another operation refinement for the autonomous configuration profile 800 for the selected tiller implement. The Make Ready for Transport refinement transitions the tiller to a road ready configuration after completion of a tillage operation. For instance, the tiller wings are retracted for transport (e.g., on roads) while driving speed is set to MANUAL for operator driving along smooth road surfaces. In one example, the threshold refinement parameter (or trigger) for the refinement 810 includes an indication that a path plan or autonomous tillage operation is completed, for instance with a field computer, GPS or RTK sensor of the sprayer and controller 414 (or implement controller 456) monitoring of operation status (e.g., 100 percent complete). Upon determination the agricultural operation is completed the Make Ready for Transport 810 refinement is initiated. For example, the actuators associated with the tiller tools, Depth Control and Rolling Baskets, are toggled to ‘OFF’ parameter values to retract the chisels, blades or the shovels and to suspend the rolling baskets. Additionally, tiller wing actuators are transitioned to the ‘ON RETRACT’ position to retract the tiller wings with associated hydraulic actuators or the like. In another example, autonomous driving actuators (steering, transmission, engine, brakes) of the vehicle portion of the agricultural assembly are operated to drive the tractor and tiller to a shed based on GPS, vision sensors or the like. The Make Ready for Transport 810 operation refinement is another example of an interrupting refinement that overrides further conduct of the Working Mode 802 base autonomous configuration profile.

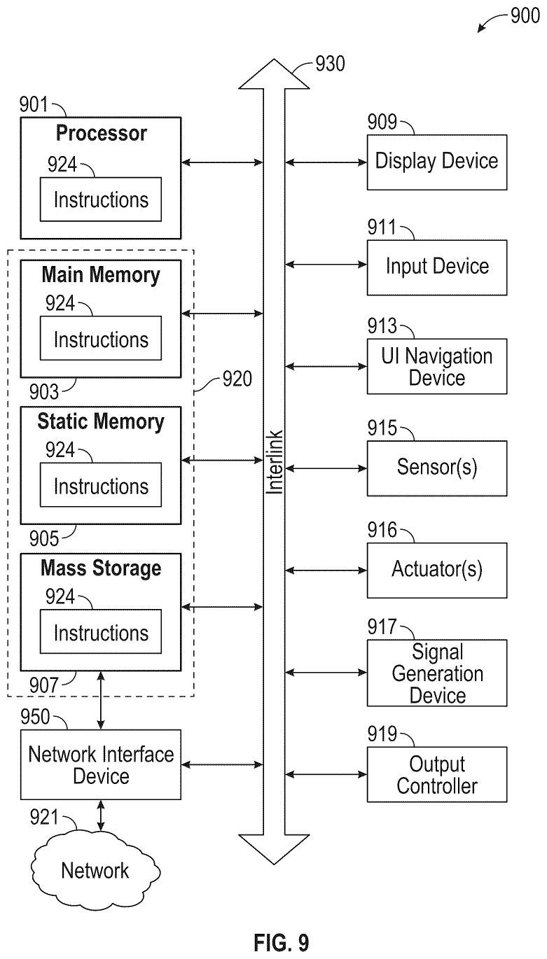

The techniques shown and described in this document are performed in various examples using a portion or an entirety of an autonomous agricultural assembly configurator, such as the configurator 400 shown in FIG. 4; agricultural vehicles 402; implements 404; or the like as described herein or otherwise using a machine 900 as discussed below in relation to FIG. 9. FIG. 9 illustrates a block diagram of an example comprising a machine 900 upon which any one or more of the techniques (e.g., methodologies) discussed herein is performed. In various examples, the machine 900 operates as a standalone device or is connected (e.g., networked) to other machines.

In a networked deployment, the machine 900 operates in the capacity of a server machine, a client machine, or both in server-client network environments. In an example, the machine 900 acts as a peer machine in peer-to-peer (P2P) (or other distributed) network environments. The machine 900 is optionally a personal computer (PC), a tablet device, a set-top box (STB), a personal digital assistant (PDA), a mobile telephone, a web appliance, a network router, switch or bridge, field computer, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership is flexible over time and underlying hardware variability. Circuitries include members that, alone or in combination, perform specified operations when operating. In an example, hardware of the circuitry is immutably designed to carry out a specific operation (e.g., hardwired). In another example, the hardware comprising the circuitry includes variably connected physical components (e.g., execution units, transistors, simple circuits, or the like) including a computer-readable medium physically modified (e.g., magnetically, electrically, such as via a change in physical state or transformation of another physical characteristic, or the like) to encode instructions of the specific operation. In connecting the physical components, the underlying electrical properties of a hardware constituent are changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components are used in more than one member of more than one circuitry. For example, under operation, execution units may be used in a first circuit of a first circuitry at one point in time and reused by a second circuit in the first circuitry, or by a third circuit in a second circuitry at a different time.

The machine 900 (e.g., computer system) may include a hardware-based processor 901 (e.g., a central processing unit (CPU), a graphics processing unit (GPU), a hardware processor core, or any combination or plurality thereof), a main memory 903 and a static memory 905, some or all of which may communicate with each other via an interlink 930 (e.g., a bus, CAN bus or the like). The machine 900 may further include one or more of a display device 909, an input device 911 (e.g., an alphanumeric keyboard), or a user interface (UI) navigation device 913 (e.g., a mouse, track pad, track ball, stylus, or the like). In an example, the display device 909, the input device 911, and the UI navigation device 913 comprise at least portions of a touch screen display. The machine 900 may additionally include a mass storage device 907 (e.g., a drive unit), a signal generation device 917 (e.g., a speaker, light system, or the like), a network interface device 950, and one or more sensors 915, such as the sensors described herein for one or both of the vehicle 402, implement 404, or the various vehicle and implement examples and equivalents for the same. In another example, the machine 900 includes one or more actuators 916, such as the actuators described herein for one or both of the vehicle 402, implement 404, or the various vehicle and implement examples and equivalents for the same. The machine 900 includes, in an example, an output controller 919, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage devices 903, 905, 907 include, but are not limited to, a machine readable medium on which is stored one or more sets of data structures or instructions 924 (e.g., software or firmware) embodying or utilized by any one or more of the techniques or functions described herein including, but not limited to, the autonomous agricultural assembly configurator 400, autonomous profile controller 414, vehicle controller 446, implement controller 456, or the like. The instructions 924 may also reside, completely or at least partially, within a main memory 904, within a static memory 906, within a mass storage device 907, or within the hardware-based processor 901 during execution thereof by the machine 900. In an example, one or any combination of the hardware-based processor 901, the main memory 903, the static memory 905, or the mass storage 907 may constitute machine readable media. In another example, one or more of the memories 903, 905, 907 retain the one or more algorithms, URLs, macros or the like associated with the autonomous configuration profile generator 410. In other examples, one or more of the memories 903, 905, 907 retain a plurality of field characteristic bundles associated with a respective plurality of fields, a plurality of implement characteristic bundles associated with a respective plurality of agricultural implements, and a plurality of vehicle characteristic bundles associated with respective plurality of agricultural vehicles including the vehicle characteristic bundle of the agricultural vehicle.

While the machine readable medium is in one example considered as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 924 may further be transmitted or received over a communications network 921 using a transmission medium via the network interface device 950 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 950 may include one or more physical jacks (e.g., Ethernet, coaxial, or phone jacks) or one or more antennas to connect to the communications network 921. In an example, the network interface device 950 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

### Various Notes and Aspects

Aspect 1 can include subject matter such as an autonomous agricultural assembly configurator comprising: one or more processors configured to: receive characteristic bundle inputs including: a field characteristic bundle associated with a field; an implement characteristic bundle associated with an agricultural implement; and a vehicle characteristic bundle associated with an agricultural vehicle; and generate an autonomous configuration profile for an autonomous agricultural operation according to the received characteristic bundle inputs including: determining the autonomous agricultural operation based on the implement characteristic bundle; and determining operation parameters for the autonomous agricultural operation based on one or more of the implement characteristic bundle or the vehicle characteristic bundle.

Aspect 2 can include, or can optionally be combined with the subject matter of Aspect 1, to optionally include wherein the field characteristic bundle includes one or more field characteristics of the field including field boundaries, obstacle locations, crop characteristics, or crop row spacing.

Aspect 3 can include, or can optionally be combined with the subject matter of one or any combination of Aspects 1 or 2 to optionally include wherein the implement characteristic bundle includes one or more implement characteristics of the agricultural implement including implement weight, implement dimensions, tool characteristics, hitch characteristics, implement sensor characteristics, or implement actuator characteristics.

Aspect 4 can include, or can optionally be combined with the subject matter of one or any combination of Aspects 1-3 to optionally include wherein the vehicle characteristic bundle includes one or more vehicle characteristics of the agricultural vehicle including vehicle dimensions, turning radius, engine characteristics, motor characteristics, pump characteristics, transmission characteristics, ground engaging element spacing, hitch characteristics, vehicle sensor characteristics, or vehicle actuator characteristics.

Aspect 5 can include, or can optionally be combined with the subject matter of one or any combination of Aspects 1-4 to optionally include wherein the received characteristic bundle inputs include one or more of: the field characteristic bundle associated with the field includes the field characteristic bundle associated with a specified field of a plurality of different fields; the implement characteristic bundle associated with the agricultural implement includes the implement characteristic bundle associated with a specified agricultural implement of a plurality of different agricultural implements; or the vehicle characteristic bundle associated with the agricultural vehicle includes the vehicle characteristic bundle associated with a specified agricultural vehicle of a plurality of different agricultural vehicles.

Aspect 6 can include, or can optionally be combined with the subject matter of Aspects 1-5 to optionally include wherein the one or more processors is configured to interface with a vehicle controller of the agricultural vehicle.

Aspect 7 can include, or can optionally be combined with the subject matter of Aspects 1-6 to optionally include wherein the one or more processors is configured to interface with an implement controller of the agricultural implement.

Aspect 8 can include, or can optionally be combined with the subject matter of Aspects 1-7 to optionally include wherein the one or more processors is distinct from a vehicle controller and an implement controller of the agricultural vehicle and implement, respectively.

Aspect 9 can include, or can optionally be combined with the subject matter of Aspects 1-8 to optionally include wherein the one or more processors is configured to control the operation of each of the agricultural vehicle and the agricultural implement according to the autonomous configuration profile of the autonomous agricultural operation.

Aspect 10 can include, or can optionally be combined with the subject matter of Aspects 1-9 to optionally include wherein controlling the operation of each of the agricultural vehicle and the agricultural implement includes: receiving sensor inputs from sensors of one or more of the agricultural vehicle or the agricultural implement based on the autonomous configuration profile; and operating one or more actuators of one or more of the agricultural vehicle or the agricultural implement based on the autonomous configuration profile.

Aspect 11 can include, or can optionally be combined with the subject matter of Aspects 1-10 to optionally include wherein determining the operation parameters for the autonomous agricultural operation includes determining the operation parameters based on the implement characteristic bundle and one or more of the field or vehicle characteristic bundles.

Aspect 12 can include, or can optionally be combined with the subject matter of Aspects 1-11 to optionally include determining a path plan for the autonomous agricultural operation based on one or more of the field, implement and vehicle characteristic bundles.

Aspect 13 can include, or can optionally be combined with the subject matter of Aspects 1-12 to optionally include wherein generating the autonomous configuration profile according to the received characteristic bundle inputs includes: generating one or more operation refinements of the autonomous agricultural operation according to one or more of the field, implement or vehicle characteristic bundles.

Aspect 14 can include, or can optionally be combined with the subject matter of Aspects 1-13 to optionally include wherein generating the autonomous configuration profile according to the received characteristic bundle inputs includes: generating one or more operation refinements through human operator queries.

Aspect 15 can include, or can optionally be combined with the subject matter of Aspects 1-14 to optionally include wherein the one or more processors includes a characteristic memory including: a plurality of field characteristic bundles associated with a respective plurality of fields including the field characteristic bundle of the field; a plurality of implement characteristic bundles associated with a respective plurality of agricultural implements including the implement characteristic bundle of the agricultural implement; and a plurality of vehicle characteristic bundles associated with respective plurality of agricultural vehicles including the vehicle characteristic bundle of the agricultural vehicle.

Aspect 16 can include, or can optionally be combined with the subject matter of Aspects 1-15 to optionally include wherein receiving characteristic bundle inputs includes receiving selections of the field, the agricultural implement, and the agricultural vehicle from the characteristic memory.

Aspect 17 can include, or can optionally be combined with the subject matter of Aspects 1-16 to optionally include wherein the one or more processors includes a characteristic investigator configured to: identify characteristics associated with one or more of the field, agricultural implement, or the agricultural vehicle; and collect one or more characteristics from the identified characteristics into the field, implement or vehicle characteristic bundles.

Aspect 18 can include, or can optionally be combined with the subject matter of Aspects 1-17 to optionally include wherein two or more of the field, vehicle, or implement characteristic bundles are included in a composite characteristic bundle.

Aspect 19 can include, or can optionally be combined with the subject matter of Aspects 1-18 to optionally include an autonomous agricultural assembly configurator and controller comprising: one or more processors configured to: receive characteristic bundle inputs including: a field characteristic bundle associated with a field; an implement characteristic bundle associated with an agricultural implement; and a vehicle characteristic bundle associated with an agricultural vehicle; and generate an autonomous configuration profile for an autonomous agricultural operation according to the received characteristic bundle inputs; and control the operation of each of the agricultural vehicle and the agricultural implement to conduct the autonomous agricultural operation according to the autonomous configuration profile.

Aspect 20 can include, or can optionally be combined with the subject matter of Aspects 1-19 to optionally include wherein controlling the operation of each of the agricultural vehicle and the agricultural implement includes: receiving sensor inputs from sensors of one or more of the agricultural vehicle or the agricultural implement based on the autonomous configuration profile; and operating one or more actuators of one or more of the agricultural vehicle or the agricultural implement based on the autonomous configuration profile.

Aspect 21 can include, or can optionally be combined with the subject matter of Aspects 1-20 to optionally include wherein generating the autonomous configuration profile includes: determining operation parameters for the autonomous agricultural operation based at least on the implement characteristic bundle; and determining a path plan for the autonomous agricultural operation based at least on the field and implement characteristic bundles.

Aspect 22 can include, or can optionally be combined with the subject matter of Aspects 1-21 to optionally include wherein the field characteristic bundle includes one or more field characteristics including field boundaries, obstacle locations, crop characteristics, agricultural prescriptions, or crop row spacing; the implement characteristic bundle includes one or more implement characteristics including implement weight, implement dimensions, tool characteristics, hitch characteristics, implement sensor characteristics, implement actuator characteristics, agricultural prescriptions; and the vehicle characteristic bundle includes one or more vehicle characteristics including vehicle dimensions, turning radius, engine characteristics, motor characteristics, transmission characteristics, ground engaging element spacing, hitch characteristics, vehicle sensor characteristics, or vehicle actuator characteristics.

Aspect 23 can include, or can optionally be combined with the subject matter of Aspects 1-22 to optionally include wherein the received characteristic bundle inputs include one or more of: the field characteristic bundle associated with the field includes the field characteristic bundle associated with a specified field of a plurality of different fields; the implement characteristic bundle associated with the agricultural implement includes the implement characteristic bundle associated with a specified agricultural implement of a plurality of different agricultural implements; or the vehicle characteristic bundle associated with the agricultural vehicle includes the vehicle characteristic bundle associated with a specified agricultural vehicle of a plurality of different agricultural vehicles.

Aspect 24 can include, or can optionally be combined with the subject matter of Aspects 1-23 to optionally include wherein the one or more processors is configured to interface with one or more of a vehicle controller of the agricultural vehicle or an implement controller of the agricultural implement.

Aspect 25 can include, or can optionally be combined with the subject matter of Aspects 1-24 to optionally include wherein the one or more processors is distinct from a vehicle controller and an implement controller of the agricultural vehicle and implement, respectively.

Aspect 26 can include, or can optionally be combined with the subject matter of Aspects 1-25 to optionally include wherein generating the autonomous configuration profile according to the received characteristic bundle inputs includes: generating one or more operation refinements of the autonomous agricultural operation according to one or more of the field, implement or vehicle characteristic bundles.

Aspect 27 can include, or can optionally be combined with the subject matter of Aspects 1-26 to optionally include wherein generating the autonomous configuration profile according to the received characteristic bundle inputs includes: generating one or more operation refinements through human operator queries.

Aspect 28 can include, or can optionally be combined with the subject matter of Aspects 1-27 to optionally include wherein the one or more processors includes a characteristic investigator configured to: identify characteristics associated with one or more of the field, agricultural implement or the like agricultural vehicle; and collect one or more characteristics from the identified characteristics into the field, implement or vehicle characteristic bundles.

Aspect 29 can include, or can optionally be combined with the subject matter of Aspects 1-28 to optionally include wherein two or more of the field, vehicle, or implement characteristic bundles are included in a composite characteristic bundle.

Aspect 30 can include, or can optionally be combined with the subject matter of Aspects 1-29 to optionally include an autonomous agricultural assembly configurator comprising: one or more processors configured to: receive characteristic bundle inputs including: a field characteristic bundle associated with a field; an implement characteristic bundle associated with an agricultural implement; and a vehicle characteristic bundle associated with an agricultural vehicle; generate an autonomous configuration profile for an autonomous agricultural operation according to the received characteristic bundle inputs; and generate one or more operation refinements, the one or more operation refinements having refinement parameters including: one or more sensor thresholds associated with available sensors included in one or more of the implement or vehicle characteristic bundles; and one or more actions associated with available actuators included in one or more of the implement or vehicle characteristic bundles, the one or more actions linked with the one or more sensor thresholds and sensors.

Aspect 31 can include, or can optionally be combined with the subject matter of Aspects 1-30 to optionally include wherein the one or more processors is configured to control the operation of each of the agricultural vehicle and the agricultural implement according to the autonomous configuration profile and the one or more operation refinements for the autonomous agricultural operation.

Aspect 32 can include, or can optionally be combined with the subject matter of Aspects 1-31 to optionally include wherein generating the one or more operation refinements of the autonomous agricultural operation according to one or more of the field, implement or vehicle characteristic bundles.

Aspect 33 can include, or can optionally be combined with the subject matter of Aspects 1-32 to optionally include wherein the received characteristic bundle inputs include one or more of: the field characteristic bundle associated with the field includes the field characteristic bundle associated with a specified field of a plurality of different fields; the implement characteristic bundle associated with the agricultural implement includes the implement characteristic bundle associated with a specified agricultural implement of a plurality of different agricultural implements; or the vehicle characteristic bundle associated with the agricultural vehicle includes the vehicle characteristic bundle associated with a specified agricultural vehicle of a plurality of different agricultural vehicles.

Aspect 34 can include, or can optionally be combined with the subject matter of Aspects 1-33 to optionally include wherein generating the one or more operation refinements includes selecting one or more available sensors or available actuators of the specified agricultural implement or specified agricultural vehicle.

Aspect 35 can include, or can optionally be combined with the subject matter of Aspects 1-34 to optionally include wherein generating the one or more operation refinements includes selecting refinement parameters according to the selected one or more available sensors or available actuators.

Aspect 36 can include, or can optionally be combined with the subject matter of Aspects 1-35 to optionally include wherein generating the one or more operation refinements includes generating the one or more operation refinements with human operator queries.

Aspect 37 can include, or can optionally be combined with the subject matter of Aspects 1-36 to optionally include wherein the one or more processors is distinct from a vehicle controller and an implement controller of the agricultural vehicle and implement, respectively.

Aspect 38 can include, or can optionally be combined with the subject matter of Aspects 1-37 to optionally include wherein generating the autonomous configuration profile includes: determining operation parameters for the autonomous agricultural operation based at least on the implement characteristic bundle; and determining a path plan for the autonomous agricultural operation based at least on the field and implement characteristic bundles.

Aspect 39 can include, or can optionally be combined with the subject matter of Aspects 1-38 to optionally include wherein two or more of the field, vehicle, or implement characteristic bundles are included in a composite characteristic bundle.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An autonomous agricultural assembly configurator comprising:
one or more processors configured to:
receive characteristic bundle inputs including:
a field characteristic bundle associated with a field;
an implement characteristic bundle associated with an agricultural implement; and
a vehicle characteristic bundle associated with an agricultural vehicle; and
generate an autonomous configuration profile for an autonomous agricultural operation according to the received characteristic bundle inputs including:
determining the autonomous agricultural operation based on the implement characteristic bundle; and
determining operation parameters for the autonomous agricultural operation based on one or more of the implement characteristic bundle or the vehicle characteristic bundle.

2. The configurator of claim 1, wherein the field characteristic bundle includes one or more field characteristics of the field including field boundaries, obstacle locations, crop characteristics, or crop row spacing.

3. The configurator of claim 1, wherein the implement characteristic bundle includes one or more implement characteristics of the agricultural implement including implement weight, implement dimensions, tool characteristics, hitch characteristics, implement sensor characteristics, or implement actuator characteristics.

4. The configurator of claim 1, wherein the vehicle characteristic bundle includes one or more vehicle characteristics of the agricultural vehicle including vehicle dimensions, turning radius, engine characteristics, motor characteristics, pump characteristics, transmission characteristics, ground engaging element spacing, hitch characteristics, vehicle sensor characteristics, or vehicle actuator characteristics.

5. The configurator of claim 1, wherein the received characteristic bundle inputs include one or more of:
the field characteristic bundle associated with the field includes the field characteristic bundle associated with a specified field of a plurality of different fields;
the implement characteristic bundle associated with the agricultural implement includes the implement characteristic bundle associated with a specified agricultural implement of a plurality of different agricultural implements; or
the vehicle characteristic bundle associated with the agricultural vehicle includes the vehicle characteristic bundle associated with a specified agricultural vehicle of a plurality of different agricultural vehicles.

6. The configurator of claim 1, wherein the one or more processors is configured to interface with a vehicle controller of the agricultural vehicle.

7. The configurator of claim 6, wherein the one or more processors is configured to interface with an implement controller of the agricultural implement.

8. The configurator of claim 1, wherein the one or more processors is distinct from a vehicle controller and an implement controller of the agricultural vehicle and implement, respectively.

9. The configurator of claim 1, wherein the one or more processors is configured to control the operation of each of the agricultural vehicle and the agricultural implement according to the autonomous configuration profile of the autonomous agricultural operation.

10. The configurator of claim 9, wherein controlling the operation of each of the agricultural vehicle and the agricultural implement includes:
receiving sensor inputs from sensors of one or more of the agricultural vehicle or the agricultural implement based on the autonomous configuration profile; and
operating one or more actuators of one or more of the agricultural vehicle or the agricultural implement based on the autonomous configuration profile.

11. The configurator of claim 1, wherein determining the operation parameters for the autonomous agricultural operation includes determining the operation parameters based on the implement characteristic bundle and one or more of the field or vehicle characteristic bundles.

12. The configurator of claim 1 comprising determining a path plan for the autonomous agricultural operation based on one or more of the field, implement and vehicle characteristic bundles.

13. The configurator of claim 1, wherein generating the autonomous configuration profile according to the received characteristic bundle inputs includes:
generating one or more operation refinements of the autonomous agricultural operation according to one or more of the field, implement or vehicle characteristic bundles.

14. The configurator of claim 1, wherein generating the autonomous configuration profile according to the received characteristic bundle inputs includes:
generating one or more operation refinements through human operator queries.

15. The configurator of claim 1, wherein the one or more processors includes a characteristic memory including:
a plurality of field characteristic bundles associated with a respective plurality of fields including the field characteristic bundle of the field;
a plurality of implement characteristic bundles associated with a respective plurality of agricultural implements including the implement characteristic bundle of the agricultural implement; and
a plurality of vehicle characteristic bundles associated with respective plurality of agricultural vehicles including the vehicle characteristic bundle of the agricultural vehicle.

16. The configurator of claim 15, wherein receiving characteristic bundle inputs includes receiving selections of the field, the agricultural implement, and the agricultural vehicle from the characteristic memory.

17. The configurator of claim 1, wherein the one or more processors includes a characteristic investigator configured to:
identify characteristics associated with one or more of the field, agricultural implement, or the agricultural vehicle; and
collect one or more characteristics from the identified characteristics into the field, implement or vehicle characteristic bundles.

18. The configurator of claim 1, wherein two or more of the field, vehicle, or implement characteristic bundles are included in a composite characteristic bundle.

19. An autonomous agricultural assembly configurator and controller comprising:
one or more processors configured to:
receive characteristic bundle inputs including:
a field characteristic bundle associated with a field;
an implement characteristic bundle associated with an agricultural implement; and
a vehicle characteristic bundle associated with an agricultural vehicle; and
generate an autonomous configuration profile for an autonomous agricultural operation according to the received characteristic bundle inputs; and
control the operation of each of the agricultural vehicle and the agricultural implement to conduct the autonomous agricultural operation according to the autonomous configuration profile.

20. The configurator and controller of claim 19, wherein controlling the operation of each of the agricultural vehicle and the agricultural implement includes:
receiving sensor inputs from sensors of one or more of the agricultural vehicle or the agricultural implement based on the autonomous configuration profile; and
operating one or more actuators of one or more of the agricultural vehicle or the agricultural implement based on the autonomous configuration profile.

21. The autonomous agricultural assembly configurator and controller of claim 19, wherein generating the autonomous configuration profile includes:
determining operation parameters for the autonomous agricultural operation based at least on the implement characteristic bundle; and
determining a path plan for the autonomous agricultural operation based at least on the field and implement characteristic bundles.

22. The configurator and controller of claim 19, wherein the field characteristic bundle includes one or more field characteristics including field boundaries, obstacle locations, crop characteristics, agricultural prescriptions, or crop row spacing;
the implement characteristic bundle includes one or more implement characteristics including implement weight, implement dimensions, tool characteristics, hitch characteristics, implement sensor characteristics, implement actuator characteristics, agricultural prescriptions; and
the vehicle characteristic bundle includes one or more vehicle characteristics including vehicle dimensions, turning radius, engine characteristics, motor characteristics, transmission characteristics, ground engaging element spacing, hitch characteristics, vehicle sensor characteristics, or vehicle actuator characteristics.

23. The configurator and controller of claim 19, wherein the received characteristic bundle inputs include one or more of:
the field characteristic bundle associated with the field includes the field characteristic bundle associated with a specified field of a plurality of different fields;
the implement characteristic bundle associated with the agricultural implement includes the implement characteristic bundle associated with a specified agricultural implement of a plurality of different agricultural implements; or
the vehicle characteristic bundle associated with the agricultural vehicle includes the vehicle characteristic bundle associated with a specified agricultural vehicle of a plurality of different agricultural vehicles.

24. The configurator and controller of claim 19, wherein the one or more processors is configured to interface with one or more of a vehicle controller of the agricultural vehicle or an implement controller of the agricultural implement.

25. The configurator and controller of claim 19, wherein the one or more processors is distinct from a vehicle controller and an implement controller of the agricultural vehicle and implement, respectively.

26. The configurator and controller of claim 19, wherein generating the autonomous configuration profile according to the received characteristic bundle inputs includes:
generating one or more operation refinements of the autonomous agricultural operation according to one or more of the field, implement or vehicle characteristic bundles.

27. The configurator and controller of claim 19, wherein generating the autonomous configuration profile according to the received characteristic bundle inputs includes:
generating one or more operation refinements through human operator queries.

28. The configurator and controller of claim 19, wherein the one or more processors includes a characteristic investigator configured to:
identify characteristics associated with one or more of the field, agricultural implement or the like agricultural vehicle; and
collect one or more characteristics from the identified characteristics into the field, implement or vehicle characteristic bundles.

29. The configurator of claim 19, wherein two or more of the field, vehicle, or implement characteristic bundles are included in a composite characteristic bundle.

30. An autonomous agricultural assembly configurator comprising:
one or more processors configured to:
receive characteristic bundle inputs including:
a field characteristic bundle associated with a field;
an implement characteristic bundle associated with an agricultural implement; and
a vehicle characteristic bundle associated with an agricultural vehicle;
generate an autonomous configuration profile for an autonomous agricultural operation according to the received characteristic bundle inputs; and
generate one or more operation refinements, the one or more operation refinements having refinement parameters including:
one or more sensor thresholds associated with available sensors included in one or more of the implement or vehicle characteristic bundles; and
one or more actions associated with available actuators included in one or more of the implement or vehicle characteristic bundles, the one or more actions linked with the one or more sensor thresholds and sensors.

31. The configurator of claim 30, wherein the one or more processors is configured to control the operation of each of the agricultural vehicle and the agricultural implement according to the autonomous configuration profile and the one or more operation refinements for the autonomous agricultural operation.

32. The configurator of claim 30, wherein generating the one or more operation refinements of the autonomous agricultural operation according to one or more of the field, implement or vehicle characteristic bundles.

33. The configurator of claim 30, wherein the received characteristic bundle inputs include one or more of:
the field characteristic bundle associated with the field includes the field characteristic bundle associated with a specified field of a plurality of different fields;
the implement characteristic bundle associated with the agricultural implement includes the implement characteristic bundle associated with a specified agricultural implement of a plurality of different agricultural implements; or
the vehicle characteristic bundle associated with the agricultural vehicle includes the vehicle characteristic bundle associated with a specified agricultural vehicle of a plurality of different agricultural vehicles.

34. The configurator of claim 33, wherein generating the one or more operation refinements includes selecting one or more available sensors or available actuators of the specified agricultural implement or specified agricultural vehicle.

35. The configurator of claim 34, wherein generating the one or more operation refinements includes selecting refinement parameters according to the selected one or more available sensors or available actuators.

36. The configurator of claim 30, wherein generating the one or more operation refinements includes generating the one or more operation refinements with human operator queries.

37. The configurator of claim 30, wherein the one or more processors is distinct from a vehicle controller and an implement controller of the agricultural vehicle and implement, respectively.

38. The configurator of claim 30, wherein generating the autonomous configuration profile includes:
determining operation parameters for the autonomous agricultural operation based at least on the implement characteristic bundle; and
determining a path plan for the autonomous agricultural operation based at least on the field and implement characteristic bundles.

39. The configurator of claim 30, wherein two or more of the field, vehicle, or implement characteristic bundles are included in a composite characteristic bundle.
